(19) United States
(12) Patent Application Publication
(10) Pub. No.: US 2012/0045024 A1
(43) Pub. Date: Feb. 23, 2012

(54) METHODS AND APPARATUS FOR ITERATIVE DECODING IN MULTIPLE-INPUT-MULTIPLE-OUTPUT (MIMO) COMMUNICATION SYSTEMS

(75) Inventors: Tao Cui, London (GB); Jia Tang, San Jose, CA (US); Andrew Sendonaris, Los Gatos, CA (US); Atul A. Salvekar, Emeryville, CA (US); Subramanya P.N. Rao, Sunnyvale, CA (US); Parvathanathan Subrahmanya, Sunnyvale, CA (US); Lei Xiao, Mountain View, CA (US); Michael L. McCloud, San Diego, CA (US); Brian Clarke Banister, San Diego, CA (US)

(73) Assignee: QUALCOMM Incorporated, San Diego, CA (US)

(21) Appl. No.: 13/033,545

(22) Filed: Feb. 23, 2011

Related U.S. Application Data
(60) Provisional application No. 61/307,768, filed on Feb. 24, 2010.

(51) Int. Cl. H04L 27/06

(52) U.S. Cl. 375/341

(57) ABSTRACT

Methods and apparatus for receiving, processing, and decoding MIMO transmissions in communications systems are described. A non-Gaussian approximation method for simplifying processing complexity where summations are used is described. Use of a priori information to facilitate determination of log likelihood ratios (LLRs) in receivers using iterative decoders is further described. A Gaussian or non-Gaussian approximation method using a priori information may be used to determine a K-best list of values for summation to generate an LLR is also described.

### CROSS-REFERENCE TO RELATED APPLICATIONS

This application claims priority under 35 U.S.C. §119(e) to U.S. Provisional Patent Application Ser. No. 61/307,768, entitled LOW COMPLEXITY HIGH PERFORMANCE ITERATIVE DECODING IN MULTIPLE INPUT MULTIPLE OUTPUT SYSTEMS, filed on Feb. 24, 2010, the content of which is hereby incorporated by reference herein in its entirety.

### FIELD

This application is directed generally to wireless communication systems. More particularly, but not exclusively, the application relates to methods and apparatus for receiving and decoding transmissions in communications systems using iterative decoding and a priori information to determine log likelihood ratios (LLRs).

### BACKGROUND

Wireless communication systems are widely deployed to provide various types of communication content such as voice, data, video and the like, and deployments are likely to increase with introduction of new data oriented systems such as Long Term Evolution (LTE) systems. Wireless communications systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, Third Generation Partnership Project (3GPP) Long Term Evolution (LTE) systems and other orthogonal frequency division multiple access (OFDMA) systems.

Generally, a wireless multiple-access communication system can simultaneously support communication for multiple wireless terminals (also know as user equipments (UEs), or access terminals (ATs). Each terminal communicates with one or more base stations (also know as access points (APs), Node Bs, Enhanced Node Bs (eNBs) via transmissions on forward and reverse links. The forward link (also referred to as a downlink or DL) refers to the communication link from the base stations to the terminals, and the reverse link (also referred to as an uplink or UL) refers to the communication link from the terminals to the base stations. These communication links may be established via a single-input-single-output (SISO), single-input-multiple-output (SIMO), multiple-input-single-output (MISO), or multiple-input-multiple-output (MIMO) system.

MIMO Orthogonal Frequency Division Multiplexing (OFDM) has been adopted for LTE-Advanced (LTE-A) systems to increase capacity and speed. Goals of LTE-A have been set to meet ambitious target data rates, such as 1 Gigabit/second (Gb/s) in local areas and 100 Megabits/second (Mb/s) in wide areas. In order to meet these goals, MIMO techniques and wide spectrum allocation of 100 MHz are expected to be deployed, which should provide potentially significant increases in wireless link capacity. However, a challenge of MIMO implementation has been demodulation and decoding complexity in receiver modules.

### SUMMARY

This disclosure relates generally to wireless communications systems. More particularly, but not exclusively, this disclosure relates to systems, methods, and apparatus for decoding transmitted signals in a wireless communications systems. The decoding may include using a priori information to enhance decoding performance and/or reduce processing complexity.

In one aspect, the disclosure relates to a method of generating a log likelihood ratio (LLR) metric that may be used to decode a transmitted signal. The method may include generating a K-best set of values, and summing the K-best set of values to generate the LLR metric. The K-best set of values may be determined based at least in part on an a priori priority value. The a priori value may be provided from a decoder module, such as from a turbo decoder.

In another aspect, the disclosure relates to a method of generating a log likelihood ratio (LLR) metric for use in decoding a transmitted signal. The method may include, for example, determining a non-Gaussian approximation for a summation term of the LLR metric, evaluating the non-Gaussian approximation of the summation term, and generating the LLR metric based in part on the evaluation.

In another aspect, the disclosure relates to a method of generating a non-Gaussian approximation of a discrete probability mass function (pmf) for use in decoding a received signal. The method may include, for example, determining a non-Gaussian function approximation corresponding to the pmf, and integrating the non-Gaussian function to replace a summation in generating a value for use in decoding the received signal.

In another aspect, the disclosure relates to a method of generating a log-likelihood (LLR) metric for use in decoding a transmitted signal in a wireless communications system. The method may include, for example, generating a K-Best list of values based in part on an a priori value provided from a turbo decoder, determining a summation based on the K-Best list of values, and generating the LLR metric based in part on the summation.

In another aspect, the disclosure relates to computer program products including computer readable storage media having instructions for causing a computer to perform the above-described methods.

In another aspect, the disclosure relates to communication apparatus and devices configured to perform the above-described methods.

In another aspect, the disclosure relates to communication devices and apparatus including means for performing the above-described methods.

Additional aspects, features, and functionality are further described below in conjunction with the appended drawings.

### BRIEF DESCRIPTION OF THE DRAWINGS

The present application may be more fully appreciated in connection with the following detailed description taken in conjunction with the accompanying drawings, wherein:

FIG. 1 illustrates a wireless communications system.

FIG. 2 illustrates a wireless communications system having multiple cells.

FIG. 3 illustrates an embodiment of a base station and user terminal in a wireless communication system.

FIG. 4 illustrates an embodiment of a system for sending and receiving MIMO transmissions.

FIG. 5 illustrates a channel model associated with the system of FIG. 4.

FIG. 6 illustrates an embodiment of details of a MIMO receiver architecture.

FIG. 7 illustrates a method of computing an log-likelihood ratio (LLR).

FIG. 8 illustrates example Gaussian and non-Gaussian probability mass function (pmf) approximations.

FIG. 9 illustrates a process for determining a non-Gaussian function for use in determining an LLR metric.

FIG. 10 illustrates a constellation and a hypersphere for use in generating a set of list values.

FIG. 11 illustrates a process for determining a list using a priori information.

FIG. 12 illustrates a method for determining list values using a polynomial approximation.

### DETAILED DESCRIPTION

In accordance with various aspects as described subsequently herein, efficient iterative detection and decoding apparatus and methods for use in MIMO-OFDM based systems, as well as other communications systems, are described.

In an iterative receiver architecture, a detector and decoder may exchange information. Various algorithms differ in how the soft information is generated from the detector. However, different processing algorithms can be shown to be equivalent to using a Gaussian approximation on the interference in the LLR value or metric computation. However, the Gaussian approximation may not work well for high order modulations such as 64 or 256 quadrature amplitude modulation (QAM), which is used in LTE and LTE-A systems. To address this and other problems, in various aspects, methods and apparatuses are described herein.

Various additional aspect, details, functions, and implementations are further described below in conjunction with the appended drawings. Although the various aspects that follow are described primarily in the context of LTE systems and use LTE terms, in various implementations, the methods and apparatuses described herein may be used for wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, Wi-Max networks, as well as other communications networks. As described, herein, the terms “networks” and “systems” may be used interchangeably.

A CDMA network may implement a radio technology such as Universal Terrestrial Radio Access (UTRA), cdma2000 and the like. UTRA includes Wideband-CDMA (W-CDMA), Time Division Synchronous CDMA (TD-SCDMA), as well as UTRA/UMTS-TDD 1.28 Mcps Low Chip Rate (LCR). Cdma2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), IEEE 802.11, IEEE 802.16, IEEE 802.20, Flash-OFDM and the like. UTRA, E-UTRA, and GSM are part of Universal Mobile Telecommunication System (UMTS). In particular, Long Term Evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). LTE is a 3GPP project aimed at improving the Universal Mobile Telecommunications System (UMTS) mobile phone standard. The 3GPP may define specifications for the next generation of mobile networks, mobile systems, and mobile devices.

The word “exemplary” is used herein to mean “serving as an example, instance, or illustration.” Any aspect and/or embodiment described herein as “exemplary” is not necessarily to be construed as preferred or advantageous over other aspects and/or embodiments.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels. The maximum spatial multiplexing N_{S} if a linear receiver is used is min(N_{T}, N_{R}), with each of the N_{S} independent channels corresponding to a dimension. This provides an N_{S} increase in spectral efficiency. A MIMO system can provide improved performance (e.g., higher throughput and/or greater reliability) if the additional dimensionalities created by the multiple transmit and receive antennas are utilized. The spatial dimension may be described in terms of a rank.

MIMO systems support time division duplex (TDD) and frequency division duplex (FDD) implementations. In a TDD system, the forward and reverse link transmissions use the same frequency regions so that the reciprocity principle allows the estimation of the forward link channel from the reverse link channel. This enables the access point to extract transmit beamforming gain on the forward link when multiple antennas are available at the access point.

In some implementations a system may utilize time division duplexing (TDD). For TDD, the downlink and uplink share the same frequency spectrum or channel, and downlink and uplink transmissions are sent on the same frequency spectrum. The downlink channel response may thus be correlated with the uplink channel response. A reciprocity principle may allow a downlink channel to be estimated based on transmissions sent via the uplink. These uplink transmissions may be reference signals or uplink control channels (which may be used as reference symbols after demodulation). The uplink transmissions may allow for estimation of a space-selective channel via multiple antennas.

In LTE, a mobile station or device may be referred to as a “terminal,” “user device,” or “user equipment” (UE). A base station may be referred to as an evolved NodeB or eNB. A semi-autonomous base station may be referred to as a home eNB or HeNB. An HeNB may thus be one example of an eNB. The HeNB and/or the coverage area of an HeNB may be referred to as a femtocell, an HeNB cell or a closed subscriber group (CSG) cell (where access is restricted).

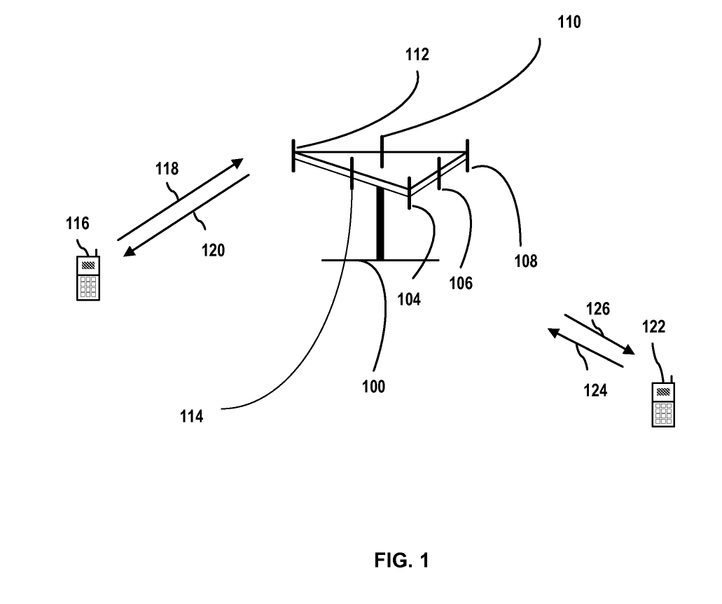

FIG. 1 illustrates an exemplary multiple access wireless communication system (e.g., LTE/LTE-A system) on which aspects as further described subsequently may be implemented. A base station or evolved NodeB (eNB) 100 (also know as an access point or AP) may include multiple antenna groups, one including 104 and 106, another including 108 and 110, and an additional one including 112 and 114. In FIG. 1, only two antennas are shown for each antenna group, however, more or fewer antennas may be utilized for each antenna group. The antennas of base station 100 may define a coverage area of a cell associated with the base station.

A user equipment (UE) 116 (also known as an access terminal or AT) may be within the cell coverage area and may be in communication with antennas 112 and 114, where antennas 112 and 114 transmit information to UE 116 over forward link (also known as a downlink or DL) 120 and receive information from UE 116 over a reverse link (also known as an uplink or UL) 118. Another UE 122 (and/or additional UEs not shown) may be in communication with antennas 106 and 108, where antennas 106 and 108 transmit information to UE 122 over forward link 126 and receive information over reverse link 124.

In a frequency division duplex (FDD) system, communication links 118, 120, 124 and 126 may use different frequency for communication. For example, forward link 120 may use a different frequency then that used by reverse link 118. In a time division duplex (TDD) system, downlinks and uplinks may share the same spectrum.

Each group of antennas and/or the area in which they are designed to communicate is often referred to as a sector of the base station, and may be associated with sector coverage areas, which may be sub-areas of the base station cell coverage area. Antenna groups may each be designed to communicate to UEs in a sector of the cell area covered by the base station 100. In communication over forward links 120 and 126, the transmitting antennas of the base station 100 may utilize beam-forming in order to improve the signal-to-noise ratio of forward links for the different UEs 116 and 122. Also, the base station may use beam-forming to transmit to UEs scattered randomly through its coverage area, which may cause less interference to UEs in neighboring cells than an eNB transmitting through a single antenna to all its UEs.

An eNB, such as the base station 100, may be a fixed station used for communicating with the UEs and may also be referred to as an access point, a Node B, or some other equivalent terminology. In some system configurations, such as heterogenous networks, the base station or eNB may be one of a variety of types and/or power levels. For example, the eNB may be associated with a macrocell, femtocell, picocell, and/or other type of cell. The eNB may be one of a range of different power levels, such as one of a type of macrocell eNB having any of a range of power levels.

A UE may also be denoted as an access terminal, AT, wireless communication device, terminal, or some other equivalent terminology. A UE may be implemented in the form of a wireless handset, computer or wireless module or device for use with a computer, personal digital assistant (PDA), tablet computer or device, or via any other similar or equivalent device or system.

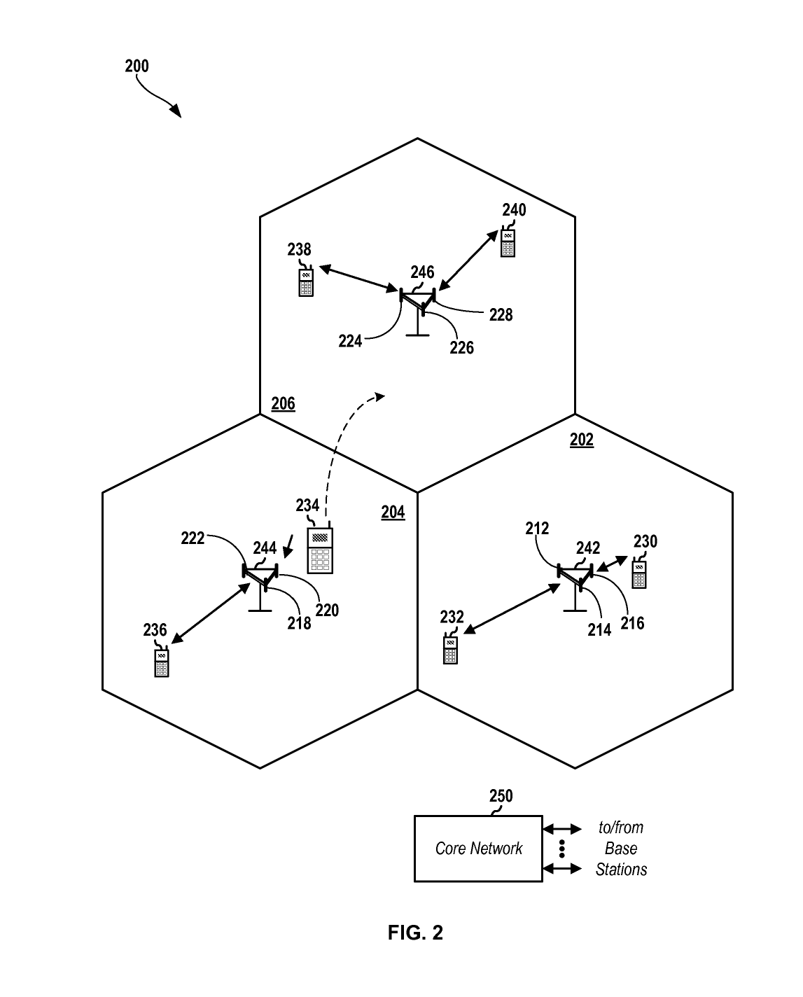

Referring to FIG. 2, which illustrates details of a wireless communication network 200 (e.g., LTE or LTE-A network). Wireless network 200 may include a number of base stations or evolved Node Bs (eNBs) as well as other network entities. An eNB may be a base station that communicates with user terminals or UEs. Each base station or eNB may provide communication coverage for a particular geographic coverage area and/or time and/or frequency-multiplexed coverage area.

As shown in FIG. 2, example communication network 200 includes cells 202, 204, and 206, which each have associated base stations or eNBs 242, 244, and 246, respectively. While cells 202, 204, and 206 are shown adjacent to each other, the coverage area of these cells and associated eNBs may overlap and/or be contiguous with each other. For example, an eNB, such as eNBs 242, 244, and 246 may provide communication coverage for a macro cell, a picocell, a femtocell, and/or other types of cell. A macrocell may cover a relatively large geographic area (e.g., several kilometers in radius) and may allow unrestricted access by UEs with service subscription. A picocell may cover a relatively small geographic area, may overlap with one or more macrocells, and/or may allow unrestricted access by UEs with service subscription. Likewise, a femtocell may cover a relatively small geographic area (e.g., a home), may overlap with a macrocell and/or picocell, and/or may allow restricted access only to UEs having association with the femtocell, e.g., UEs for users in the home, UEs for users subscribing to a special service plan, etc. An eNB for a macrocell may be referred to as a macro eNB or macro base station or macrocell node. An eNB for a picocell may be referred to as a pico eNB, pico base station or picocell node. An eNB for a femtocell may be referred to as a femto eNB, home eNB, femto base station or femtocell node.

A network controller element or core network element 250 may couple to a set of eNBs and provide coordination and control for these eNBs. Network controller 250 may be a single network entity or a collection of network entities. Network controller 250 may communicate with eNBs 242, 244, and 246 via a backhaul connection to a core network (CN) function. eNBs 242, 244, and 246 may also communicate with one another, e.g., directly or indirectly via wireless or wireline backhaul.

In some implementations, wireless network 200 may be a homogeneous network that includes only macro base stations or eNBs. Wireless network 200 may also be a heterogeneous network or hetnet that includes eNBs of different types, e.g., macro eNBs, pico eNBs, femto eNBs, relay nodes (RNs), etc. These different types of eNBs may have different transmit power levels, different coverage areas, and different impact on interference in wireless network 200.

For example, macro eNBs may have a high transmit power level (e.g., 20 Watts) whereas pico eNBs, femto eNBs, and relays may have a lower transmit power level (e.g., 1 Watt). The various techniques and aspects described herein may be used in different implementations for homogeneous and heterogeneous networks.

Network 200 may include one or more UEs. For example, network 200 may include UEs 230, 232, 234, 236, 238 and 240 (and/or other UEs not shown). The various UEs may be dispersed throughout wireless network 200, and each UE may be stationary, mobile, or both. As described previously, a UE may communicate with an eNB via a downlink (DL) and an uplink (UL). The downlink (or forward link) refers to the communication link from the eNB to the UE, and the uplink (or reverse link) refers to the communication link from the UE to the eNB. A UE may be able to communicate with macro eNBs, pico eNBs, femto eNBs, relay nodes, and/or other types of eNBs. In FIG. 2, a solid line with double arrows indicates desired transmissions between a UE and a serving eNB, which is an eNB designated to serve the UE on the downlink and/or uplink.

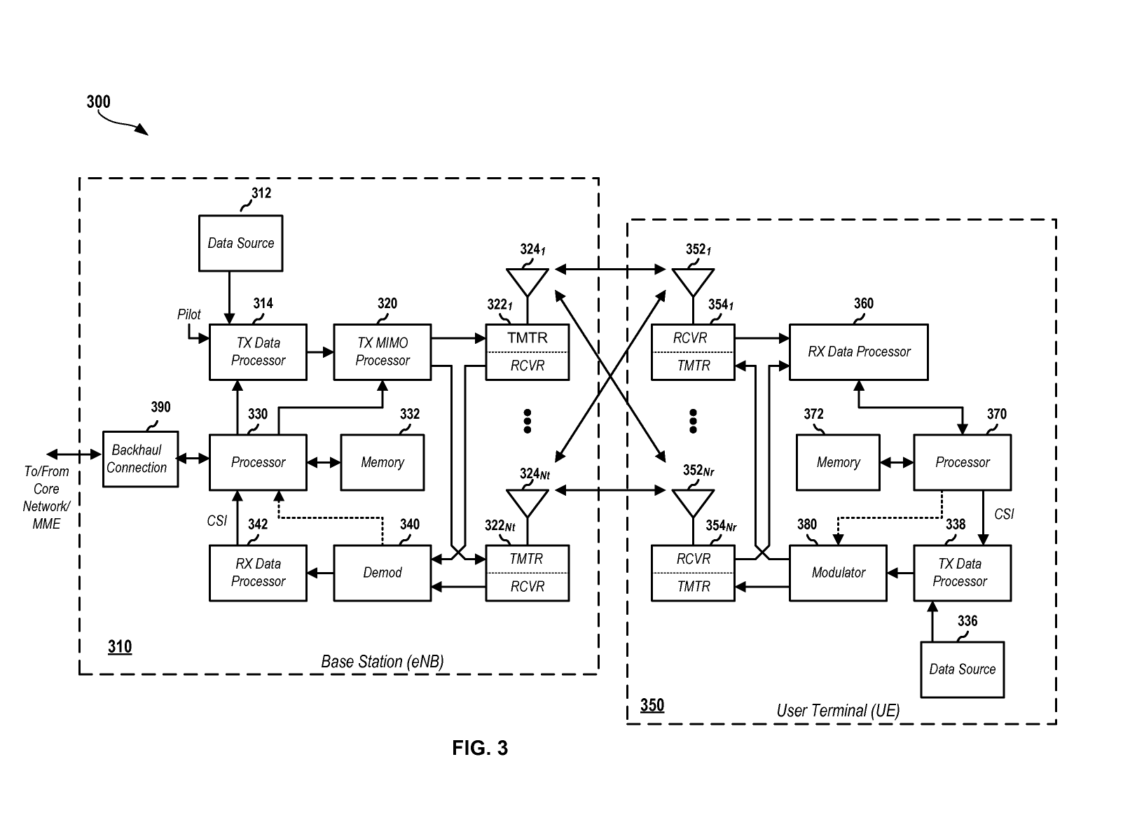

Referring to FIG. 3, which illustrates a block diagram of an embodiment of base station 310 (i.e., an eNB, HeNB, etc.) and a UE 350 on which aspects and functionality as described subsequently herein may be implemented. Various functions may be performed in the processors and memories as shown in base station 310 (and/or in other components not shown), such as communications with other base stations (not shown) of other cells and/or networks, to transmit and receive signaling from the other base stations and UEs, as well as to provide other functionality as described herein, such as MIMO signal transmission and receiption processing functionality.

For example, UE 350 may include one or more modules to receive signals from base station 310 and/or other base stations (not shown, such as non-serving base stations or base stations of other network types as described previously herein) to access base stations, receive DL signals, determine channel characteristics, perform channel estimates, demodulate received data and generate spatial information, determine power level information, and/or other information associated with base station 310 or other base stations (not shown).

Base station 310 may coordinate with other base stations as described herein to facilitate operations such as forward handovers. This may be done in one or more components (or other components not shown) of base station 310, such as processors 314, 330 and memory 332. Base station 310 may also include a transmit module including one or more components (or other components not shown) of eNB 310, such as transmit modules 322. Base station 310 may include an interference cancellation module including one or more components (or other components not shown), such as processors 330, 342, demodulator module 340, and memory 332 to provide functionality such as redirection of served UEs, communication with associated MMEs, or other network nodes, signaling redirection information, PS suspension information, handover and context information, and/or other information such as is described herein.

Base station 310 may include a processor module including one or more components (or other components not shown), such as processors 330, 314 and memory 332 to perform base station functions as described subsequently herein and/or manage transmitter and/or receiver modules, which may be used to communicate with UEs or other nodes, such as other base stations, MMEs, etc. Base station 310 may also include a control module for controlling receiver functionality. Base station 310 may include a network connection module 390 to provide networking with other systems, such as backhaul systems in the core network (CN), as well as other base stations/eNBs, such as via module 390, or with other components such as are shown herein.

Likewise, UE 350 may include a receive module including one or more components, such as receivers 354 to receive and process MIMO signals. UE 350 may also include a processor module including one or more components (or other components not shown), such as processors 360 and 370, and memory 372, to perform the processing functions associated with MIMO functionality as described subsequently herein. This may include, for example, receiving, decoding, and processing received signal from two or more antennas.

Two or more signals received at UE 350 are processed to receive DL signals and/or extract information such as MIB and SIB information from the DL signals. Additional processing may include estimating channel characteristics, power information, spatial information, and/or other information associated with eNBs, such as base station 310 and/or other base stations, such as Node Bs (not shown), as well as facilitating communicating with other cells or networks and associated nodes, such as base stations or Node Bs of those different networks.

Memory 332 (and/or other memories not shown in FIG. 3) may be used to store computer code for execution on one or more processors, such as processors 314, 320, 330, and 342 (and/or other processors of base station 310 that are not shown) to implement processes associated with the aspects and functionality described herein related to MIMO signal reception and processing. Likewise, memory 372 (and/or other memories not shown) may be used to store computer code for execution on one or more or more processors, such as processors 338, 360, and 370 to implement processes associated with the aspects and functionality described herein. The memories may be used, for example, to store information such as context information, cell and user terminal identity information, as well as other information associated with wireless device and system operation.

At the base station 310, traffic data for a number of MIMO data streams may be provided from a data source 312 to a transmit (TX) data processor 314, where the data may be processed and transmitted to one or more UEs 350. In one aspect, each data stream is processed and transmitted over a respective transmitter sub-system (shown as transmitters 322₁-322_{N1}, and antennas 324₁-324_{N1}) of base station 310. TX data processor 314 receives, formats, codes, and interleaves the traffic data for each data stream based on a particular coding scheme selected for that data stream so as to provide coded data. In particular, base station 310 may be configured to determine a particular reference signal and reference signal pattern and provide a transmit signal including the reference signal and/or beamforming information in the selected pattern.

The coded data for each data stream may be multiplexed with pilot data using OFDM techniques. The pilot data is typically a known data pattern that is processed in a known manner and may be used at the receiver system to estimate the channel response. For example, the pilot data may include a reference signal. Pilot data may be provided to TX data processor 314 as shown in FIG. 3 and multiplexed with the coded data. The multiplexed pilot and coded, data for each data stream may then be modulated (i.e., symbol mapped) based on a particular modulation scheme (e.g., BPSK, QSPK, M-PSK, M-QAM, etc.) selected for that data stream so as to provide modulation symbols, and the data and pilot may be modulated using different modulation schemes. The data rate, coding, and modulation for each data stream may be determined by instructions performed by processor 330 based on instructions stored in memory 332, or in other memory or instruction storage media of UE 350 (not shown).

The modulation symbols for all data streams may then be provided to a TX MIMO processor 320, which may further process the modulation symbols (e.g., for OFDM implementation). TX MIMO processor 320 may then provide Nt modulation symbol streams to Nt transmitters (TMTR) 322₁ through 322_{Nt}. The various symbols may be mapped to associated RBs for transmission.

TX MIMO processor 320 may apply beamforming weights to the symbols of the data streams and corresponding to the one or more antennas from which the symbol is being transmitted. This may be done by using information such as channel estimation information provided by or in conjunction with the reference signals and/or spatial information provided from a network node such as a UE. For example, a beam B=transpose([b₁ b₂ . . . b_{Nt}]) composes of a set of weights corresponding to each transmit antenna. Transmitting along a beam corresponds to transmitting a modulation symbol x along all antennas scaled by the beam weight for that antenna; that is, on antenna t the transmitted signal is bt*x. When multiple beams are transmitted, the transmitted signal on one antenna is the sum of the signals corresponding to different beams. This can be expressed mathematically as B₁x₁+B₂x₂+B_{Ns}x_{Ns}, where Ns beams are transmitted and xᵢ is the modulation symbol sent using beam Bᵢ. In various implementations beams could be selected in a number of ways. For example, beams could be selected based on channel feedback from a UE, channel knowledge available at the base station, or based on information provided from a UE to facilitate interference mitigation, such as with an adjacent macrocell.

Each transmitter sub-system 322₁ through 322_{Nt} receives and processes a respective symbol stream to provide one or more analog signals, and further conditions (e.g., amplifies, filters, and upconverts) the analog signals to provide a modulated signal suitable for transmission over the MIMO channel. Nt modulated signals from transmitters 322₁ through 322_{Nt} are then transmitted from Nt antennas 324₁ through 324_{Nt}, respectively.

At UE 350, the transmitted modulated signals are received by Nr antennas 352₁ through 352_{Nr} and the received signal from each antenna 352 is provided to a respective receiver (RCVR) 354₁ through 352_{Nr}. Each receiver 354 conditions (e.g., filters, amplifies and downconverts) a respective received signal, digitizes the conditioned signal to provide samples, and further processes the samples to provide a corresponding “received” symbol stream.

An RX data processor 360 then receives and processes the Nr received symbol streams from Nr receivers 354₁ through 352_{Nr} based on a particular receiver processing technique so as to provide Ns “detected” symbol streams so at to provide estimates of the Ns transmitted symbol streams. The RX data processor 360 then demodulates, deinterleaves, and decodes each detected symbol stream to recover the traffic data for the data stream. The processing by RX data processor 360 is typically complementary to that performed by TX MIMO processor 320 and TX data processor 314 in base station 310.

A processor 370 may periodically determine a precoding matrix. Processor 370 may then formulate a reverse link message that may include a matrix index portion and a rank value portion. In various aspects, the reverse link message may include various types of information regarding the communication link and/or the received data stream. The reverse link message may then be processed by a TX data processor 338, which may also receive traffic data for a number of data streams from a data source 336 which may then be modulated by a modulator 380, conditioned by transmitters 354₁ through 354_{Nr}, and transmitted back to base station 310. Information transmitted back to base station 310 may include power level and/or spatial information for providing beamforming to mitigate interference from base station 310.

At base station 310, the modulated signals from UE 350 are received by antennas 324, conditioned by receivers 322, demodulated by a demodulator 340, and processed by a RX data processor 342 to extract the message transmitted by UE 350. Processor 330 may then determine which pre-coding matrix to use for determining beamforming weights, and then processes the extracted message.

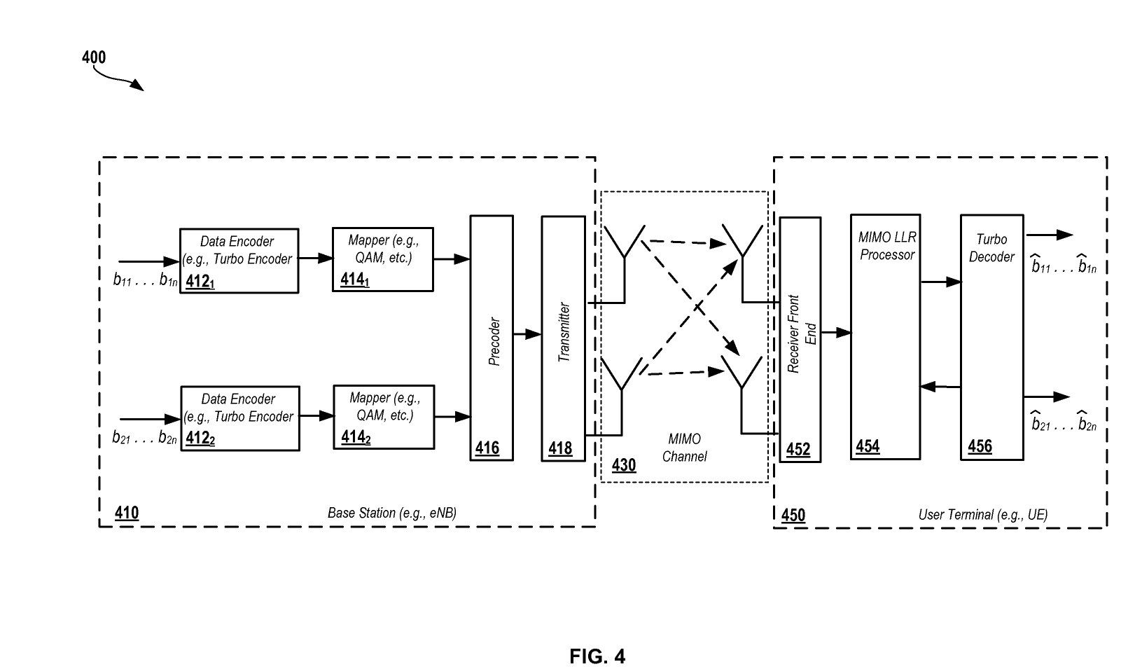

FIG. 4, illustrates is a MIMO system 400 with a signal transmission apparatus 410, which may be a component of a transmission module of a base station such as base station 310 (FIG. 3), and/or a transmission module of a user terminal, such as UE 350 FIG. 3). Likewise, a MIMO receiver apparatus 450 may be a component of a receiver module of a user terminal or base station. Transmission apparatus 410 may include data encoder modules 412, which may be, for example, turbo decoders, which may map bits to corresponding streams and antennas for MIMO transmissions. Module 410 may include a precoder module 416, which may apply coding to the streams, and a transmitter module 418, which may be used to generate and amplify an RF signal for transmission via multiple antennas. The transmitted signal propagates through a channel 430, which may be characterized as described subsequently herein using a channel matrix, H.

Receive apparatus 450 may include multiple antennas (e.g., in the examples describes subsequently 2 antennas are used, however, other antenna configurations and antenna numbers may be used in various embodiments). One or more receiver front end modules 452 may downconvert the signals received from the multiple antennas and provide an output to a MIMO processor 454. The MIMO processor may include a demapper module, which may include a joint LLR module, such as described subsequently, for generating an LLR metric for use in decoding the received signals. A turbo decoder 456 may be coupled to the demapper module, such as further illustrated and described subsequently. In particular, a priori information from the turbo decoder 456 may be used to improve and/or simplify decoding performance as described subsequently herein.

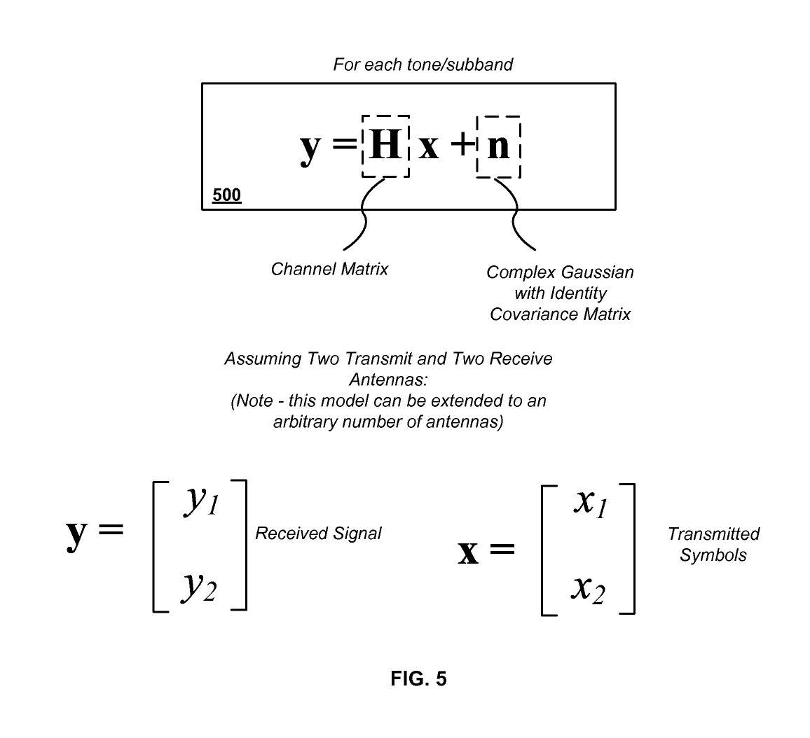

FIG. 5 illustrates a channel model 500 for a MIMO system having two antennas (e.g., two transmit and two receive antennas). In model 500, the received signal vector, y, represents symbols received on antenna 1 (y₁) and antenna 2 (y₂), respectively. Similarly, vector x represents the transmitted signal vector, H, represents the MIMO channel between transmitter and receiver (e.g., a channel matrix), and n represents the noise component, which may be represented as complex Gaussian with an identity covariance matrix. The goal at the receiver is to jointly decode the transmitted vector x, e.g., symbols x₁ and x₂ from y, e.g., received signals y₁ and y₂.

It is noted that this example and the subsequent examples are illustrated with respect to a two antenna configuration for purposes of clarity, however, the various aspects may be implemented in systems having configurations with more than two antennas in various configurations.

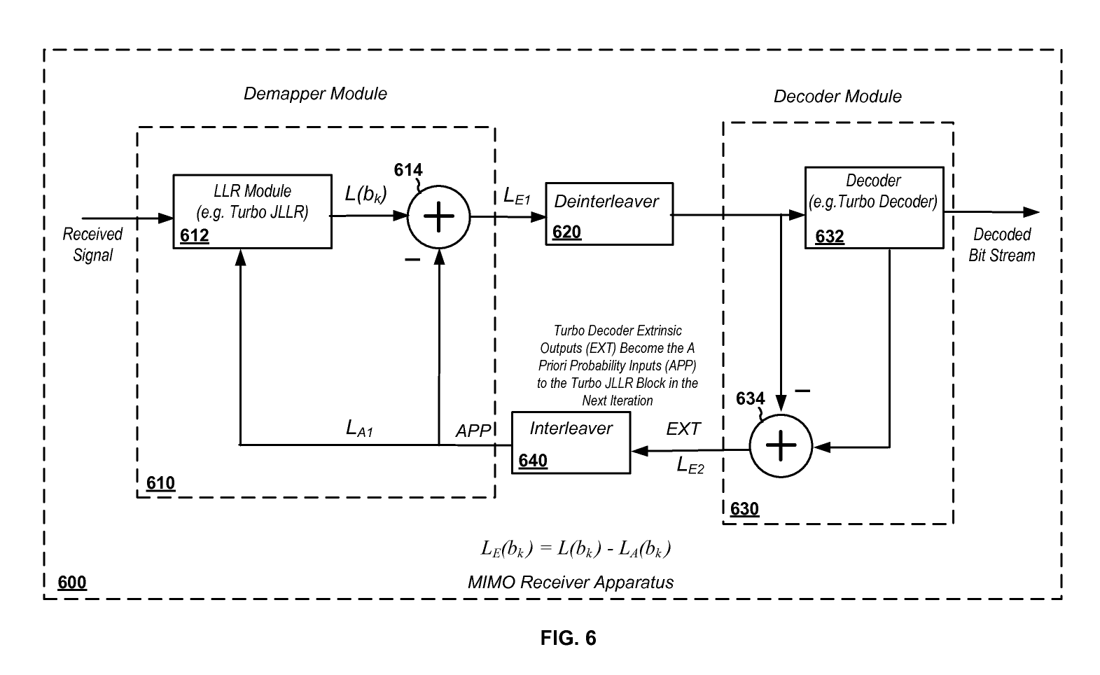

FIG. 6 illustrates details of an embodiment of an iterative decoder configuration as may be used in, for example, a receiver apparatus 600 of a wireless communications device to send transmit vector x, such as shown in FIG. 5. Apparatus 600 may be configured with an inner loop module or apparatus 630 that may include a decoder element such as decoder 632 for decoding codes such as convolutional codes. The inner loop apparatus 630 may generate so-called extrinsic information as the output of adder module 634, which may be provided to a demapper or outer loop apparatus 610 to improve decoding performance. An interleaver 640 and deinterleaver 620 may be coupled between the inner loop apparatus 630 and demapper apparatus 610 as shown.

At the demapper 610, the extrinsic information may be used to improve the estimation of the received signal provided to a Log Likelihood Ratio (LLR) module 612. The LLR module 612 may be configured to compute an LLR metric, L(bₖ). Summation modules 614 and 634 may be included to add signal components as shown to generate L_{E1} and L_{E2}.

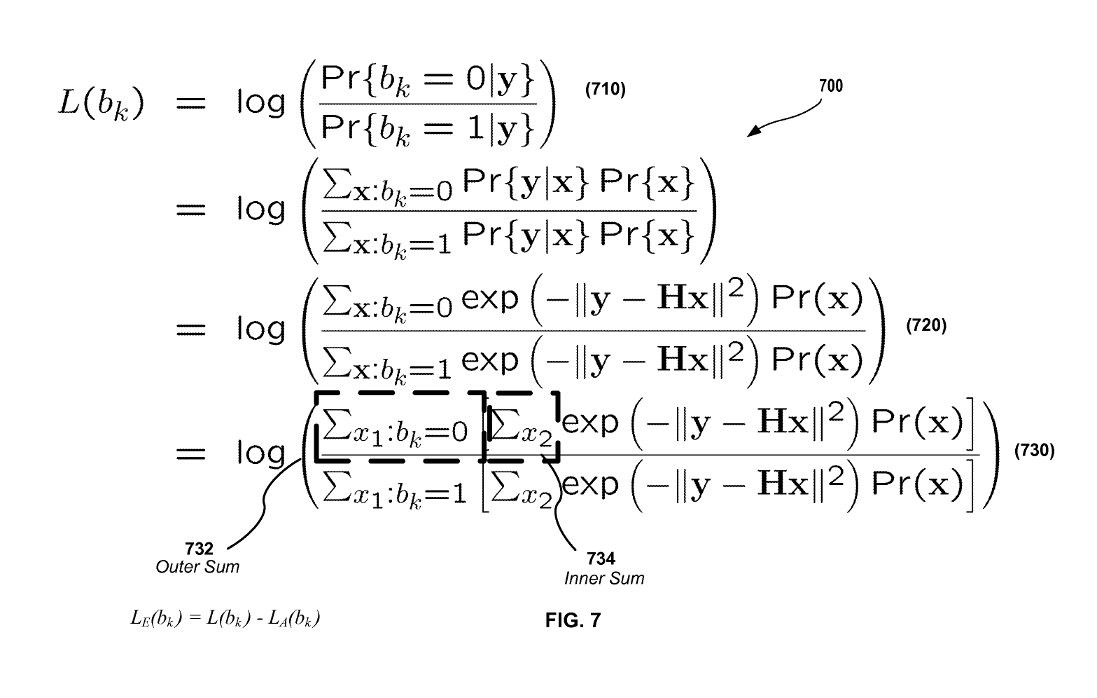

FIG. 7 illustrates details of a processing computation mechanism 700 for determining an LLR value or metric (also denoted herein as an “LLR” for brevity) associated with bit bₖ. It is noted that, while this processing embodiment is illustrated with respect to a two antenna case and two corresponding summations (over x₁ and x₂), the processing can be extended to an arbitrary antenna configuration by adding additional summations as well as equivalent continuous functions approximations as described subsequently.

As shown in equation 710, the LLR, L(bₖ) may be defined as the logarithm of the ratio of conditional probabilities that bₖ=0 and bₖ=1 summed over x₁ and x₂. Equation 710 may be rewritten in the form of equations 720 and 730 as shown in FIG. 7. Equation 730 may be represented as an outer sum term 732 (over x₁) and an inner sum term 734 (over x₂).

However, the complexity of the calculation required to solve equation 730 can be complex and processor intensive, particularly with larger symbol constellations. For example, in the case of a 256 QAM symbol constellation, summing x₁ and x₂ (for 2 antennas) over 256 values requires 64K (i.e. 65,536) calculations. In addition, configurations with more than two antennas may further add to the complexity and time for generating the LLR. Therefore, it may be desirable to reduce the number of terms in the summation or otherwise simplify the computation.

As can be seen in equation 720, the term ∥y−Hx∥ represents a noise magnitude metric. As the value of the estimation of x approaches the correct value, the magnitude of the noise metric term (y−Hx) in equations 720 and 730 will decrease and the square of this term will be corresponding smaller. Consequently, the exponential of the minus-squared term will be large relative to larger noise metric values. This may result in a summation where only a few terms corresponding to values of x closest to the actual value dominate the sum. Accordingly, in one simplification approach, the smaller-valued terms for y−Hx may be discarded as they will add a relatively small amount to the sum. This can be viewed as identifying a smaller number of summation terms that contribute most of the value to the nested sum.

One solution to simplifying the summation over x₂ as shown in FIG. 7 involves replacing the summation with integration by using a Gaussian approximation for the probability mass function (pmf). An example of this approach is illustrated below, where the summation over x₂ is replaced with the integration as shown below:

$$\begin{matrix}L ( {b}_{k} ) = log \frac{{\sum }_{{x}_{1} : {b}_{k} = 0}^{ } Pr ( {x}_{1} ) {\sum }_{{x}_{2}}^{ } exp ( - {‖ y - Hx ‖}^{2} ) Pr ( {x}_{2} )}{{\sum }_{{x}_{1} : {b}_{k} = 1}^{ } Pr ( {x}_{1} ) {\sum }_{{x}_{2}}^{ } exp ( - {‖ y - Hx ‖}^{2} ) Pr ( {x}_{2} )} \\ = log \frac{{\sum }_{{x}_{1} : {b}_{k} = 0}^{ } Pr ( {x}_{1} ) \int exp ( - {‖ y - Hx ‖}^{2} ) Pr ( {x}_{2} ) d {x}_{2}}{{\sum }_{{x}_{1} : {b}_{k} = 1}^{ } Pr ( {x}_{1} ) \int exp ( - {‖ y - Hx ‖}^{2} ) Pr ( {x}_{2} ) d {x}_{2}}\end{matrix} \qquad \begin{matrix}\begin{matrix}\begin{matrix}\begin{matrix}\begin{matrix}\begin{matrix}( 1 ) \\ \end{matrix} \\ \end{matrix} \\ \end{matrix} \\ \end{matrix} \\ \end{matrix} \\ ( 2 )\end{matrix}$$

Existing implementations assume that the probability density function for x₂ in equation (2) is Gaussian, which can be solved in a close form fashion as follows:

$$Pr ( y \vert {x}_{1} ) = {\sum }_{{x}_{2}}^{ } Pr ( y \vert {x}_{1} , {x}_{2} ) Pr ( {x}_{2} ) \approx {\int }_{- ∞}^{+ ∞} Pr ( y \vert {x}_{1} , {x}_{2} ) f ( {x}_{2} ) d {x}_{2} ∝ exp ( - {( y - {h}_{2} {μ}_{2} - {h}_{1} {x}_{1} )}^{H} {R}^{- 1} ( y - {h}_{2} {μ}_{2} - {h}_{1} {x}_{1} ) ) , \\ where , \\ {μ}_{2} E \{ {x}_{2} \} = {\sum }_{{x}_{2}}^{ } Pr ( {x}_{2} ) {x}_{2} \\ {v}_{2}^{2} = E \{ \vert {x}_{2} {\vert}^{2} \} - {E}^{2} \{ {x}_{2} \} = {\sum }_{{x}_{2}}^{ } Pr ( {x}_{2} ) \vert {x}_{2} {\vert}^{2} - \vert {μ}_{2} {\vert}^{2} \\ R = {h}_{2} {v}_{2}^{2} {h}_{2}^{H} + {σ}^{2} {I}_{2} \qquad \begin{matrix}\begin{matrix}\begin{matrix}\begin{matrix}\begin{matrix}( 3 ) \\ \end{matrix} \\ ( 4 )\end{matrix} \\ \end{matrix} \\ \end{matrix} \\ \begin{matrix}\begin{matrix}\begin{matrix}\begin{matrix}( 5 ) \\ \end{matrix} \\ ( 6 )\end{matrix} \\ \end{matrix} \\ ( 7 )\end{matrix}\end{matrix}$$

Although Gaussian estimations of probability density such as described above may be used to simplify LLR determination by approximating a discrete probability mass function (pmf), they may not provide a good model of the probability characteristics.

In accordance with one aspect, this disclosure relates to generation and use of non-Gaussian probability approximations for use in LLR determination. Non-Gaussian approximations may be used, for example, directly in LLR determination such as described below. Alternately, or in addition, they may be used as discussed later in this disclosure to determine a K-best list of values for use in summations to determine an LLR.

To motivate use of non-Gaussian approximations, as one example, a four-phase amplitude modulation (4-PAM) implementation may have a symbol constellation where four possible symbols values are transmitted, corresponding to symbol X values of X=−3, −1, 1, and 3. This distribution may correspond to a two bit (b₁ , b₂) mapping via, for example, a gray code mapping (or other code to, for example, minimize the number of bit errors associated with a symbol error) as follows: (di-bit (0,1) maps to symbol value −3, (0,0) maps to −1, (1,0) maps to 1, and (1,1) maps to value 3).

If the probability of bit b1=1 is 0.6 and the probability of b₂=1 is 0.8, the corresponding probabilities are described by the pmf below:

Pr(X=−3)=0.32

Pr(X=−1)=0.08

Pr(X=1)=0.12

and

Pr(X=3)=0.48 (8)

A continuous probability density function estimate may be generated corresponding to the discrete pmf values shown in (8) above, which may then be integrated (rather than summed as shown in inner sum 720 of FIG. 7). For example, a Gaussian distribution may be used as described previously in equation (4).

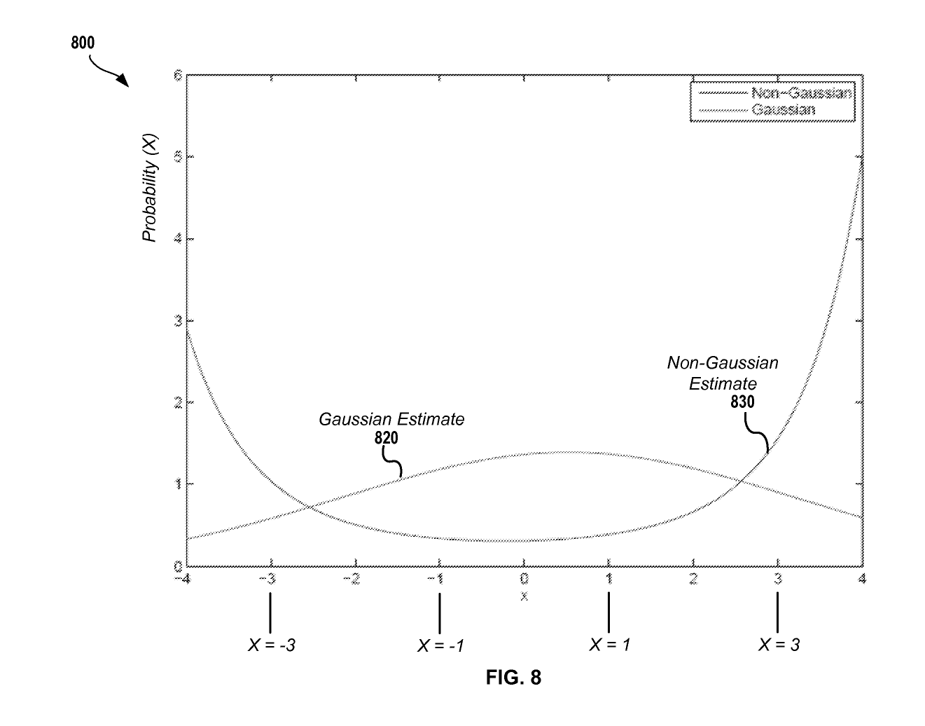

However, a Gaussian approximation may generate a probability density estimate that may have a poor correspondence with the actual discrete probability mass and may therefore not provide a good integral approximation of the summation shown in FIG. 7. An example of this is shown in FIG. 8, which illustrates continuous function estimates corresponding to a Gaussian distribution estimate 820. The underlying discrete probability mass function has larger values at the tails (e.g., at X=−3 and X=3), and smaller values near the center of the distribution (where X=0), whereas the Gaussian estimate peaks near the center of the distribution.

Instead of using a Gaussian probability estimate (which would correspond with estimate curve 820 as shown in FIG. 8), a non-Gaussian estimate or approximation may alternately be used to generate an LLR metric in various embodiments. In some implementations, the non-Gaussian estimate may be generated as a continuous probability density function estimate.

An example of one embodiment of a non-Gaussian function 830 that may be used for the described 4-PAM case is illustrated in FIG. 8. In this case, the non-Gaussian function's values more closely approximates the discrete probability distribution near the symbols of interest (e.g., at X=−3, −1, 1, and 3). Discrete pmf is: Pr(X=−3)=0.32; Pr(X=−1)=0.08; Pr(X=1)=0.12; and Pr(X=3)=0.48. Using such as non-Gaussian function can improve LLR generation and overall receiver detection performance.

Examples of embodiments of processes for generating such as non-Gaussian function that may be used for LLR determination are further described below.

For example, in the case of Binary Phase Shift Keying (BPSK) modulation, where it is assumed that the random variable X (corresponding to the transmitted symbol) takes on the discrete values +1 and −1, where the probability that X=1 (Pr(X=1))=p, and Pr(X=−1)=1−p).

This discrete probability mass function (pmf) can be approximated by the function shown below, which can then be integrated:

$$Pr ( X = x ) = {p}^{{( \frac{x + 1}{2} )}^{2}} {( 1 - p )}^{{( \frac{x - 1}{2} )}^{2}} , x = \pm 1. \qquad ( 9 )$$

For a given modulation constellation Q, with Pr(X=xᵢ)=pᵢ and Σpᵢ=1, the pmf can be written in a polynomial form as:

$$\begin{matrix}Pr ( X = x ) = {\prod }_{{x}_{i} ∈}^{ } {p}_{i}^{\frac{{\prod }_{{x}_{j} ∈ \cdot {x}_{j} \neq {x}_{i}}^{ } {( x - {x}_{j} )}^{2}}{{\prod }_{{x}_{j} ∈ \cdot {x}_{j} \neq {x}_{i}}^{ } {( {x}_{i} - {x}_{j} )}^{2}}} , x ∈ \\ = exp ( {\sum }_{l = 0}^{2 ( \vert \vert - 1 )} {a}_{l} {x}^{l} ) .\end{matrix} \qquad \begin{matrix}\begin{matrix}\begin{matrix}\begin{matrix}( 10 ) \\ \end{matrix} \\ \end{matrix} \\ \end{matrix} \\ ( 11 )\end{matrix}$$

The polynomial shown above in equation (11) is, however, difficult to integrate since, although a closed form exists for a 2^{nd} order polynomial, a closed form is not known for 3^{rd} order or higher polynomials.

In various embodiments, the pmf may be instead be approximated with a second order polynomial approximation in the exponential function for any constellation. For example, the following approximation for Pr(X=x) may be used:

Pr(X=x)=exp(−(c+2rx+ax²)) (12)

In this case, the coefficients may be determined as follows, which minimizes the distance to the desired values:

$${min}_{a , r , c} {\sum }_{i}^{ } {{ω}_{i} ( exp ( - ( c + 2 {rx}_{i} + {ax}_{i}^{2} ) ) - {p}_{i} )}^{2} \qquad ( 13 )$$

Curve 830 of FIG. 8 illustrates an implementation of such a second order polynomial approximation for the 4-PAM example described previously.

By generating a closed-form approximation for the probability density function, such as by using the above-described non-Gaussian approximation and coefficients, and integrating over the resulting continuous function, a simplified closed form LLR approximation value may be determined, which may be used to improve decoder efficiency and/or performance. In some implementations, other functions, for example other functional forms that provide closed form or otherwise efficient integration processing may be used in place of or in addition to a polynomial function.

In addition, in some embodiments it may be desirable to limit the bounds of integration for an x₂ summation (or other similar or equivalent summation) used to generate an LLR metric. For example, the closed form Gaussian function integration, such as described previously herein and illustrated in FIG. 8, would typically be taken from minus infinity to infinity. However, practical constellations have finite alphabets. For example, in two dimensional pulse-amplitude modulation (2D-PAM), the alphabet is limited to [−2D+1, −2D+3, . . . , 2D−3, 2D−1}. Therefore, integration may be bounded within a range. For example, the range may be from −U to U, where one possible value of U may be 2D. Similar integration bounding may be used with other functions, such as non-Gaussian summation approximations described previously.

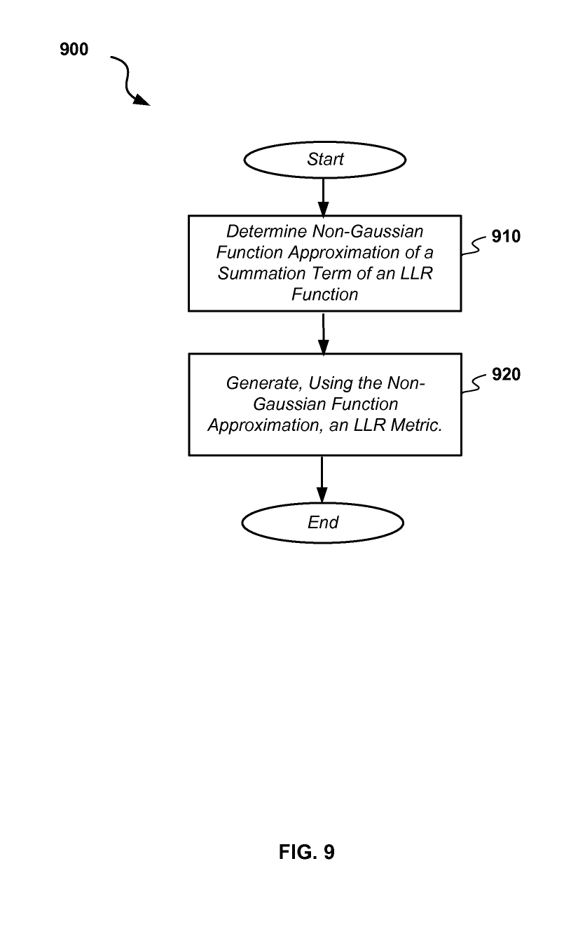

Attention is now directed to FIG. 9, which illustrates details of a process 900 which may be used in a receiver apparatus, such as may be incorporated in a user terminal, such as a UE or other device, and/or in a base station, such as an eNB or other base station, to determine an LLR metric.

In some implementations, the non-Gaussian approximation as described previously can be used to replace a summation term (e.g., the inner sum term as shown in FIG. 7) to simplify LLR generation. In this case, the summation may then be done over a set of integrals over x₁ (rather than two nested sums over x₂ and x₁), thereby reducing processing complexity.

However, in some implementations it may further be advantageous to use Gaussian and non-Gaussian information to generate a list of values over which to sum. For example, by taking advantage of a priori information as may be provided from a turbo decoder module such as shown in FIGS. 4 and 6, list selection may be enhanced over existing approaches.

As noted previously, in general, certain terms of the summation shown in equation 730 may dominate. In one implementation, the summation may be replaced by a determined maximum term (e.g., a term that contributes a large amount to the total value of the sum). In this case the other terms may be discarded, with the maximum value used in place of the sum. This approach is known as the Max-Log Approximation (MLM), which can be used to approximate the LLR value as follows:

$$L ( {b}_{i} ) \approx {max}_{x ∈ {X}_{i , + 1}} \{ - \frac{{‖ y - Hx ‖}^{2}}{{σ}^{2}} + {\sum }_{j = 0 , j \neq i , {b}_{j} = 1}^{{\sum }_{m = 1}^{M} {C}_{m} - 1} {L}_{A} ( {b}_{j} ) \} - {max}_{x ∈ \cdot {X}_{i , - 1}} \{ - \frac{{‖ y - Hx ‖}^{2}}{{σ}^{2}} + {\sum }_{j = 0 , j \neq i , {b}_{j} = 1}^{{\sum }_{m = 1}^{M} {C}_{m} - 1} {L}_{A} ( {b}_{j} ) \} . \qquad ( 14 )$$

Another approach is known as the K-Best implementation (also denoted herein as the “traditional K-Best” approach).

In the traditional approach, the “K” best candidates (where K may take on predefined values such as 3, 4, 8, 16, or other values) are identified so as to minimize the noise term (e.g. ∥y−Hx∥) squared.

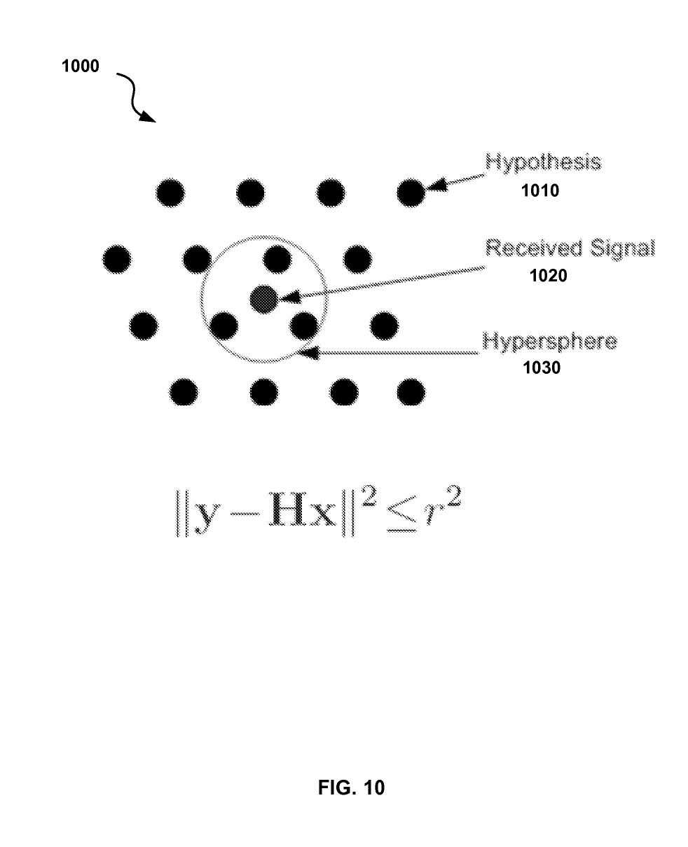

For example, this approach can be considered in the context of a 2-dimensional signal constellation 1000 as shown in FIG. 10. As shown in FIG. 10, with received signal 1020, a hypersphere 1020 may be identified (e.g., a circle in a 2-dimensional constellation as shown). A list sphere decoder (LSD) may be used to search only over a list of values determined within the hypersphere.

In this approach, the radius, r, of the hypersphere may be selected based on a noise metric, such as as a function of ∥y−Hx∥ squared. Consequently, if the noise metric is small, the radius of hypersphere 1030 will be small, whereas with a higher noise metric the radius will be larger. The radius may be iterated to narrow the search to the K-Best values for additional to the list, i.e., the goal is to identify K hypothesis values 1010 within an area, volume, etc., defined by the hypersphere. The list is generated by checking only points within the hypersphere of radius r, for example, as follows:

$${L}_{E} ( {b}_{i} \vert y ) \approx {max}_{x ∈ ℒ ⋂ {X}_{L + 1}} \{ - \frac{{‖ y - Hx ‖}^{2}}{{σ}^{2}} + {\sum }_{j = 0 , j \neq i , {b}_{j} = 1}^{{\sum }_{m = 1}^{M} {C}_{m} - 1} {L}_{A} ( {b}_{j} ) \} - {max}_{x ∈ ℒ ⋂ {X}_{L + 1}} \{ - \frac{{‖ y - Hx ‖}^{2}}{{σ}^{2}} + {\sum }_{j = 0 , j \neq i , {b}_{j} = 1}^{{\sum }_{m = 1}^{M} {C}_{m} - 1} {L}_{A} ( {b}_{j} ) \} . \qquad ( 15 )$$

The traditional K-Best approach does not, however, use a priori information for list generation. In accordance with one aspect, additional performance improvement may be obtained in a receiver by using a priori information to determine or choose the list values (also denoted here as an a priori K-Best list or a priori list). This information may be exchanged between, for example, a demapper and a turbo decoder element such as are shown in FIGS. 4 and 6. For example, an implementation based on the K-Best approach with additional a priori information may be used to determine the list.

One embodiment of this approach may be implemented as follows. Assuming that bₖ belongs to data stream 1, the K best x₁ values may be determined such that the conditional probability of x₁ conditioned on y is maximized (i.e. max Pr(x₁/y)).

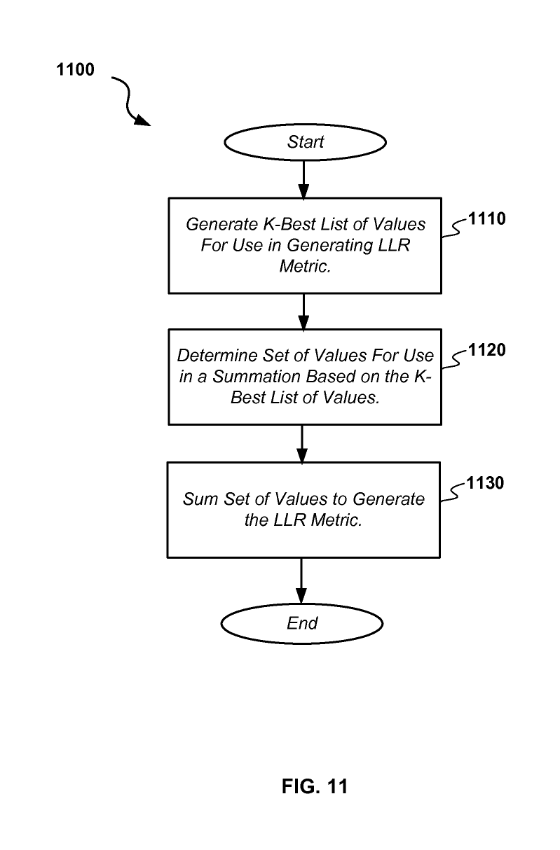

FIG. 11 illustrates an embodiment of a process 1100 for determining an LLR metric using this approach. At stage 1110, a set of K-Best list of values for use in a generating the LLR metric, with the list determined based at least in part on a priori information, which may be based on maximization of a conditional probability of x₁ given the received signal, y. At stage 1120, a set of of values for use in a summation may be determined. These may be, for example, the K-Best list values and/or additional values and/or a subset of the list values. At stage 1130, the set of values may be summed so as to generate the LLR metric.

One approach to generating the conditional probability is to use a Gaussian approximation of Pr(x₁/y). For example, the conditional probability Pr(x₁ /y) may be determined as:

$$Pr ( {x}_{1} \vert y ) = {\sum }_{{x}_{2}}^{ } Pr ( {x}_{1} , {x}_{2} \vert y ) ∝ {\sum }_{{x}_{2}}^{ } Pr ( y \vert {x}_{1} , {x}_{2} ) Pr ( {x}_{2} ) \qquad ( 16 )$$

Information related to the probability of x₂ may be known from the turbo decoder. In equation (16) above, the summation term can be approximated by an integral as:

x∫Pr(y|x₁,x₂)f(x₂)dx₂ (17)

This integral may use a Gaussian or a non-Gaussian continuous function approximation for the pmf of x₂ (e.g., f(x₂)). For example, a Gaussian approximation closed form solution be used as follows:

∝exp(−(y−h₂μ₂−h₁x₁)^{H}R⁻¹(y−h₂μ₂−h₁x₁)) (18)

Alternately, a non-Gaussian function approximation, such as described previously, may also be used for f(x₂).

By using this approach, a set of values may be selected to maximize the sum (e.g., choose the K-Best x₁ to maximize x₁ conditioned on y (e.g., maximize equation 18)). For each x₁, the best x₂ can be found, resulting in K-best pairs of x₁,x₂. These K-best pairs may then be used in the summation to generate the LLR metric.

For example, after the K-Best list of x₁, x₂ values (or, in the case of systems with additional antennas, the best values over the total of the received signals conditioned on y) are be found (i.e., by taking into account the a priori information such as described above), equation (19) below may be evaluated over only the list values (e.g., rather than performing the summation over all possible values, only the a priori determined K-Best list values are included in the summation):

$$L ( {b}_{k} ) = log \frac{{\sum }_{{x}_{1} : {b}_{k} = 0}^{ } Pr ( {x}_{1} ) {\sum }_{{x}_{2}}^{ } exp ( - {‖ y - Hx ‖}^{2} ) Pr ( {x}_{2} )}{{\sum }_{{x}_{1} : {b}_{k} = 1}^{ } Pr ( {x}_{1} ) {\sum }_{{x}_{2}}^{ } exp ( - {‖ y - Hx ‖}^{2} ) Pr ( {x}_{2} )} \qquad ( 19 )$$

Since equation (18) is a quadratic form, processing as described subsequently may be used to simplify the calculation. In general, in order to determine the a priori K-Best values, the goal is to determine the pairs x₁, x₂ corresponding to the a priority K-Best values, (e.g., the best x₂ value for each determined x₁ value). A direct approach to computing the a priori K-Best values would be to evaluate the equation for each x₁ to find the maximum valued x₁, x₂ pair to generate the list. However, this creates complexity as the constellation size increases because each x₁ value must be evaluated (e.g., for a 256 QAM constellation, 256 values of x₁ would need to be evaluated).

In one approach, once the x₁ values are found, the best x₂ values may then be found as shown in equation (19), where, for each x₁^{(k)} from equation (18), a Hard-SIC hypothesis may be calculated as:

g₊(x₁^{(k)},x₂)=exp(−∥y−h₁x₁^{(k)}−h₂x₂∥²)Pr(x₁^{(k)},x₂) (20)

In this case, the probability of x₁^{(k)}, x₂ may be approximated by a continuous function, such as a Gaussian function as described previously. In this case, it becomes quadratic in x₂, thereby allowing efficient evaluation, such as described subsequently. Using this approach, the LLR metric may then be determined as:

$$LLR ( {b}_{i} ) = log ( \frac{{\sum }_{k = 1}^{K} exp ( {g}_{+} ( {x}_{1}^{[ k ]} , {x}_{2}^{[ k ]} ) )}{{\sum }_{k = 1}^{K} exp ( {g}_{-} ( {x}_{1}^{[ k ]} , {x}_{2}^{[ k ]} ) )} ) \qquad ( 21 )$$

A closed form solution for equation 20 can be expressed as a second order polynomial in x₂, and the exponential form is also quadratic. Similarly, for the non-Gaussian approximation, a second order polynomial form can be used (such as described previously herein).

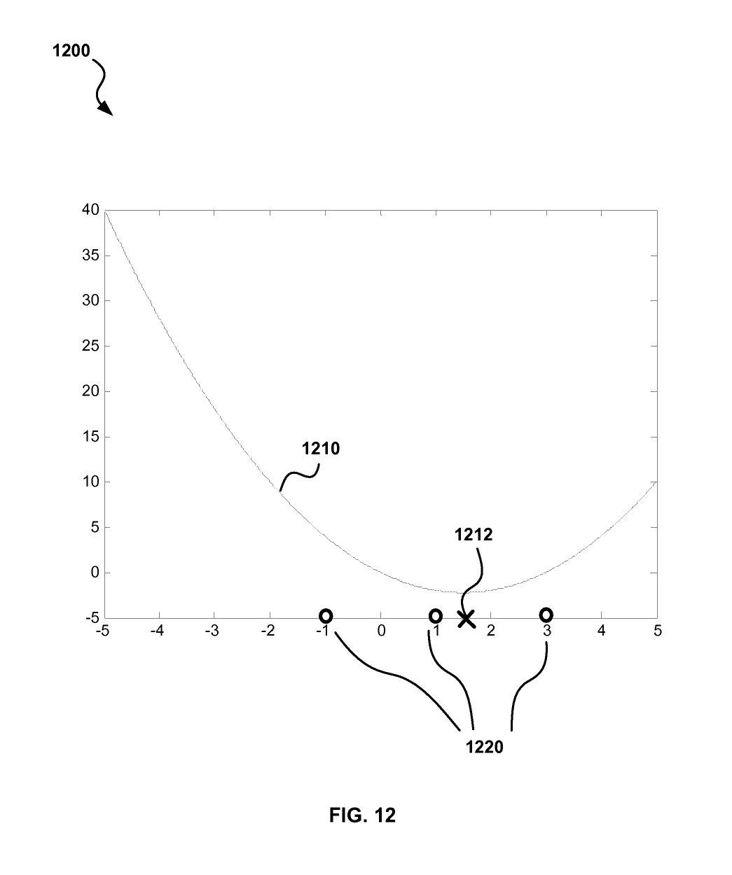

Using this approach, the values can be readily identified by finding the minimum value on the polynomial curve. An example of this is illustrated in graph 1200 of FIG. 12. In this example, an example polynomial function 1210 (equation 22) is illustrated.

Ax₁²+2Bx₁+C (22)

Polynomial function 1210 may correspond to either a Gaussian or non-Gaussian approximation, such as described previously. The a priori K-Best values may be obtained by determining the minimum value of the polynomial function and searching for the nearest symbol values. For example, in one search strategy list values are searched in a zigzag fashion from the minimum function value −B/A.

For example, in the example of FIG. 11, the minimum polynomial value 1212 may provide a starting point, and the 3 nearest symbol constellation values 1220 located at −1, 0, and 1 (assuming K=3) may be identified by searching progressively outward from the minimum value 1212 for the closest values (e.g., points 1220 in this example).

As described previously with respect to equations 16-18, 20, and 21, a summation embodiment where the a priori K-best x₁ values are identified such that Pr(x_{1.}y) is maximized is described. This approach may be denoted as the a priori K-Best Sum approach.

In another embodiment, denoted as an a priori K-best Max approach, a priori K-Best x₁ values may be determined so that the maxₓ₂Pr(x₁,x₂/y) is maximized. In this approach, a continuous function approximation may be used, such as using a Gaussian or non-Gaussian function. If x₂ is approximated as Gaussian, such as described previously, the polynomial search method as described with respect to FIG. 12 may be used. If the Gaussian approximation is used, it can be shown that the a priori K-best Max approach is equivalent to the a priori K-best Sum approach.

As shown in equation (18), a matrix inversion is required to evaluate the exponential function (i.e., R⁻¹). In general, evaluating this inversion is complex. In accordance with another aspect, the matrix inversion may be simplified by reducing the dimension of the matrix. One embodiment of this approach is described in the subsequent exemplary embodiment section. In addition, details of an exemplary embodiment of processing for performing channel inversion are also described.

The disclosure that follows provides various additional details, features, and functions associated with embodiments for LTE OFDM implementations. These details are provided for purposes of further explanation of various aspects, and are not in any way intended to be limiting.

An example MIMO OFDM system with M transmit and N receive antennas may be considered as follows. The example system has Nₛ subcarriers in an OFDM block. There are M data streams to be transmitted. The constellation [symbol] ₘ is applied on stream m, where Cₘ is the number of bits per constellation symbol. The incoming bits of each stream m of length NₛCₘRₘ,m=1, . . . ,M, is encoded using a channel code (typically a convolutional or turbo code) of rate Rₘ, resulting in a bit vector bₘ. The encoded bits are converted into symbols using a mapping function x_{i,m}=Mₘ(bₘ((i−1)Cₘ+1:iCₘ)) (e.g., Gray mapping and set partitioning mapping), i=0, . . . ,Nₛ−1, where x_{i,m} is the symbol to be transmitted over subcarrier i and antenna m (using Matlab notation). The Inverse Discrete Fourier Transform (IDFT) of the data block x_{0,m}, . . . ,x_{Ns-1,m} yields the time domain sequence, i.e.,

$${X}_{j , m} = \frac{1}{\sqrt{{N}_{s}}} {\sum }_{i = 0}^{{N}_{s} - 1} {x}_{i , m} {e}^{j2π ij / {N}_{s}} , j = 0 , … , {N}_{s} - 1. \qquad ( A1 )$$

The time domain symbol X_{j,m} is assumed to obey the component-wise energy constraint E{2X_{j,m}2²}=Eₛ/M. A cyclic prefix (CP) is added to mitigate for the residual ISI due to previous OFDM symbol. After parallel-to-serial (P/S) conversion, the signal is transmitted from the corresponding antenna. The channel between each transmitter/receiver pair is modeled as multipath channel. The channel between transmit antenna m and receive antenna n is expressed as

$${h}_{n , m} ( t ) = {\sum }_{l = 0}^{{Γ}_{n , m} - 1} {α}_{n , m , l} δ ( t - {τ}_{n , m , l} ) , \qquad ( A2 )$$

where Γ_{n,m} is the number of taps, α_{n,m,l} is the lth complex path gain, and τ_{n,m,l} is the corresponding path delay. A block fading model may be assumed, where the channel is assumed to be constant in each OFDM data block.

At the receiver side, serial-to-parallel (S/P) conversion is first performed and the CP is removed. After DFT operation, the received signal in frequency domain can be expressed as

$${y}_{i , n} = {\sum }_{m = 1}^{M} {H}_{i , n , m} {x}_{i , m} + {w}_{i , n} , i = 0 , … , {N}_{s} - 1 , n = 1 , … N , \qquad ( A3 )$$

where n denotes the receiver antenna indexing, w_{i,n} is the additive white Gaussian noise (AWGN) with zero mean and variance σ², and

$${H}_{i , n , m} = \frac{1}{\sqrt{{N}_{s}}} {\sum }_{l = 0}^{{Γ}_{n , m} - 1} {α}_{n , m , l} {e}^{- j2π [ {τ}_{n , m , l} / {T}_{s} ] i / {N}_{s}} , \qquad ( A4 )$$

where Tₛ is the symbol duration. (A4) can be written in vector form as

yᵢ=Hᵢx_{i+w}ᵢ,i=0, . . . , Nₛ−1. (A5)

The MIMO-OFDM system may be modeled as shown in FIG. 4. The signal described in (A5) can be considered as a MIMO system on each subcarrier, and the subscript i in (A5) is generally omitted subsequently herein for clarity. In some MIMO models coding is done across the transmit antennas, however, coding is done across subcarriers in MIMO-OFDM, and the M data streams are assumed to be independent.

Relationships between existing iterative decoding and detection algorithms are described below. The channel code and the MIMO channel can be considered as a serially concatenated scheme with an outer channel encoder and inner constellation mapping with block encoding matrix Hᵢ at each subcarrier. To decode b₁, . . . ,b_{M}, the optimal joint detector and decoder should compute the likelihood of each bit given all the received signals y₀, . . . ,y_{Ns-1} on all subcarriers. However, this is generally computationally impractical in practice. Several algorithms, such as those described previously in the papers cited, solve this problem approximately using the “turbo principle”, where information is exchanged between the detector (inner mapping) and decoder (outer encoder) in an iterative fashion until desired performance is attained.

Extrinsic information at each subcarrier may use the received signals on this subcarrier using the a priori information on each bits from the channel decoder. The generated extrinsic information on all subcarriers may then put into the soft in and soft out channel decoder (e.g., Bahl-Cocke-Jelinek-Raviv (BJCR) algorithm) for the next iteration decoding and detection.

Different joint detection and decoding algorithms share the same outer channel decoder. Their difference lies in how the extrinsic information from the inner mapping is generated and used. An iterative decoding and demodulation for a MIMO-OFDM consistent with the configuration shown in FIG. 6 may be used in various implementations.

The a priori probability (APP) is usually expressed as a log-likelihood ratio (LLR) value, whose magnitude indicates the reliability of the decision. In the examples described subsequently, the logical zero for a bit is represented by amplitude level bᵢ=−1 and logical one by bᵢ=+1, respectively.

After obtaining the APP from the channel decoder (initially the APP is set to be zero), the a posteriori LLR value of the bit bᵢ, i=0, . . . , Σₘ₌₁^{M}Cₘ−1 conditioned on the received vector y is

$$L ( {b}_{i} \vert y ) = log \frac{Pr ( {b}_{i} = + 1 \vert y )}{Pr ( {b}_{i} = - 1 \vert y )} . \qquad ( A6 )$$

If it is assumed that the interleaver at the encoder is ideal such that the bits in each modulation symbol are approximately statistically independent of one another, (A6) can be rewritten using Bayes' theorem as

$$\begin{matrix}L ( {b}_{i} \vert y ) = log \frac{{\sum }_{x ∈ {X}_{i , + 1}}^{ } Pr ( x \vert y )}{{\sum }_{x ∈ {X}_{i , - 1}}^{ } Pr ( x \vert y )} \\ = log \frac{{\sum }_{x ∈ {X}_{i , + 1}}^{ } Pr ( x \vert y ) Pr ( x )}{{\sum }_{x ∈ {X}_{i , - 1}}^{ } Pr ( x \vert y ) Pr ( x )} \\ = log \frac{{\sum }_{x ∈ {X}_{i , + 1}}^{ } Pr ( x \vert y ) {\prod }_{j = 0 , j \neq i}^{{\sum }_{m = 1}^{M} {C}_{m} - 1} Pr ( {b}_{j} = {B}_{j} ( x ) )}{\underbrace{{\sum }_{x ∈ {X}_{i , + 1}}^{ } Pr ( x \vert y ) {\prod }_{j = 0 , j \neq i}^{{\sum }_{m = 1}^{M} {C}_{m} - 1} Pr ( {b}_{j} = {B}_{j} ( x ) )}_{{L}_{ɛ} ( {b}_{i} \vert y )}} + \\ \underbrace{log \frac{Pr ( {b}_{i} = + 1 )}{Pr ( {b}_{i} = - 1 )} .}_{{L}_{A} ( {b}_{i} )}\end{matrix} \qquad ( A7 )$$

where X_{i,+1} and X_{i,-1} are the set of 2 Σₘ₌₁^{M}Cₘ−1 symbols vectors such that the i-th bit is +1 or −1, respectively, i.e., X_{i,±1}={x|M(b)=x, bᵢ=±1}, b=B(x) is the inverse mapping of x=M(b) and Bⱼ(x) is the j-th bit of B(x).

In case of Gaussian channel as in (A5), L(bᵢ|y) can further be written as:

$$L ( {b}_{i} \vert y ) = log \frac{{\sum }_{x ∈ {X}_{i , + 1}}^{ } exp ( - \frac{{‖ y - Hx ‖}^{2}}{{σ}^{2}} ) {\prod }_{j = 0 , j \neq i}^{{\sum }_{m = 1}^{M} {C}_{m} - 1} Pr ( {b}_{j} = {B}_{j} ( x ) )}{{\sum }_{x ∈ {X}_{i , - 1}}^{ } exp ( - \frac{{‖ y - Hx ‖}^{2}}{{σ}^{2}} ) {\prod }_{j = 0 , j \neq i}^{{\sum }_{m = 1}^{M} {C}_{m} - 1} Pr ( {b}_{j} = {B}_{j} ( x ) )} + {L}_{A} ( {b}_{i} ) . \qquad ( A8 )$$

Using the definition of L_{A}(bᵢ), (A8) can be rewritten as:

$$L ( {b}_{i} \vert y ) = log \frac{{\sum }_{x ∈ {X}_{i , + 1}}^{ } exp ( - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) )}{{\sum }_{x ∈ {X}_{i , - 1}}^{ } exp ( - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) )} + {L}_{A} ( {b}_{i} ) . \qquad ( A9 )$$

Instead of using (A9) directly, max-log approximation is adopted to compute L_{E}(bᵢ|y) as:

$${L}_{E} ( {b}_{i} \vert y ) \approx {max}_{x ∈ {X}_{i , + 1}} \{ - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) \} - {max}_{x ∈ {X}_{i , - 1}} \{ - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) \} \qquad ( A10 )$$

However, the simplification in equation (A10) still has a complexity exponential in the total number of bits or Σₘ₌₁^{M}Cₘ−1. A list sphere decoder (LSD) is used to resolve this issue by searching only over a list [symbol] containing N_{cand} elements, i.e.,

$${L}_{E} ( {b}_{i} \vert y ) \approx {max}_{x ∈ ℒ ⋂ {X}_{i , + 1}} \{ - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) \} - {max}_{x ∈ ℒ ⋂ {X}_{i , - 1}} \{ - \frac{{‖ y - Hx ‖}^{2}}{{σ}^{2}} + {\prod }_{j = 0 , j \neq i , {b}_{j} = 1}^{{\sum }_{m = 1}^{M} {C}_{m} - 1} {L}_{A} ( {b}_{j} ) \} . \qquad ( A11 )$$

The list is generated by checking only points within the hypersphere of radius r, i.e.,

∥y−Hx∥²≦r². (A12)

The list choose N_{cand} points within the hypersphere that make ∥2y−Hx∥ smallest. The radius r is chosen according to the noise variance such that the number of points within the hypersphere is not far away from N_{cand}. The performance of the LSD based algorithm depends on the size of the list. When the list size is equal to the number of all possible constellation points, i.e., 2Σₘ₌₁^{M}Cₘ−1, (A11) reduces to (A10).

In one implementation, iterative detection using a Gaussian approximation may be used. As described previously, the complexity of directly computing the LLR value from (A7) is high. (A7) can be written as:

$$\begin{matrix}L ( {b}_{i} \vert y ) = log \frac{{\sum }_{x ∈ {X}_{i , + 1}}^{ } Pr ( y \vert x ) Pr ( x )}{{\sum }_{x ∈ {X}_{i , - 1}}^{ } Pr ( y \vert x ) Pr ( x )} \\ = log \frac{{\sum }_{{x}_{m} ∈ {X}_{i , + 1}^{m}}^{ } Pr ( {x}_{m} ) Pr ( y \vert {x}_{m} )}{{\sum }_{{x}_{m} ∈ {X}_{i , + 1}^{m}}^{ } Pr ( {x}_{m} ) Pr ( y \vert {x}_{m} )} \\ = log \frac{{\sum }_{{x}_{m} ∈ {X}_{i , + 1}^{m}}^{ } Pr ( {x}_{m} ) {\sum }_{{x}_{- m}}^{ } Pr ( y \vert {x}_{- m} , {x}_{m} ) Pr ( {x}_{- m} )}{{\sum }_{{x}_{m} ∈ {X}_{i , + 1}^{m}}^{ } Pr ( {x}_{m} ) {\sum }_{{x}_{- m}}^{ } Pr ( y \vert {x}_{- m} , {x}_{m} ) Pr ( {x}_{- m} )} ,\end{matrix} \qquad ( A13 )$$

where xₘ denotes the symbol that bi belongs to, i.e., Σ_{m′=1}^{m-1}C_{m′}≦i<Σ_{m′=1}^{m}C_{m′}·x₋ₘ denotes the vector contains all entries of x except the m-th entry, and X_{i,+1}^{m} and X_{i,-1}^{m} are the set of 2^{Cm-1} symbols such that bᵢ is +1 or −1, respectively. From (A13), Σₓ₋ₘPr(y|x₋ₘ,xₘ)Pr(x₋ₘ) is computed for any given xₘ.

A suboptimal approach is to replace the summation over x₋ₘ with an integration over a continuous distribution, such as described previously herein. One typical assumption is to use the Gaussian distribution. Assuming the entries of x₋ₘ are independent Gaussian random variables with mean:

$${μ}_{{m}^{′}} = E \{ {x}_{{m}^{′}} \} = {\sum }_{{x}_{{m}^{′}} ∈ {C}_{{m}^{′}}}^{ } Pr ( {x}_{{m}^{′}} ) {x}_{{m}^{′}} \qquad ( A14 )$$

and variance:

$$\begin{matrix}{v}_{{m}^{′}}^{2} = E \{ \vert {x}_{{m}^{′}} {\vert}^{2} \} - {E}^{2} \{ {x}_{{m}^{′}} \} \\ = {\sum }_{{x}_{{m}^{′}} ∈ {C}_{{m}^{′}}}^{ } Pr ( {x}_{{m}^{′}} ) \vert {x}_{{m}^{′}} {\vert}^{2} - \vert {μ}_{{m}^{′}} {\vert}^{2} ,\end{matrix} \qquad ( A15 )$$

m′=1, . . . ,M, m′□m. When Gaussian channel model (5) is used:

$$\begin{matrix}Pr ( y \vert {x}_{m} ) = {\sum }_{{x}_{- m}}^{ } Pr ( y \vert {x}_{- m} , {x}_{m} ) Pr ( {x}_{- m} ) \approx \\ {\int }_{- ∞}^{+ ∞} Pr ( y \vert {x}_{- m} , {x}_{m} ) f ( {x}_{- m} ) d {x}_{- m} \\ = {\int }_{- ∞}^{+ ∞} \frac{1}{{( {πσ}^{2} )}^{N}} exp ( - \frac{{‖ y - {H}_{- m} {x}_{- m} - {h}_{m} {x}_{m} ‖}^{2}}{{σ}^{2}} ) \times \\ \frac{1}{{π}^{N} {\prod }_{{m}^{′} = 1 , {m}^{′} \neq m}^{M} {v}_{{m}^{′}}^{2}} exp \\ ( - {\sum }_{{m}^{′} = 1 , {m}^{′} \neq m}^{M} \frac{\vert {x}_{{m}^{′}} - {μ}_{{m}^{′}} {\vert}^{2}}{{v}_{{m}^{′}}^{2}} ) d {x}_{- m} ∝ \\ exp ( \begin{matrix}- {( y - {H}_{- m} {μ}_{- m} - {h}_{m} {x}_{m} )}^{H} {R}_{m}^{- 1} \\ ( y - {H}_{- m} {μ}_{- m} - {h}_{m} {x}_{m} )\end{matrix} ) ,\end{matrix} \qquad ( A16 )$$

where the integral is from −∞ to ∞ in each dimension, H₋ₘ contains the columns of H except the m-th column, hₘ is the m-th column of H, μ₋ₘ=[μ₁, . . . ,μₘ₋₁, μₘ₊₁, . . . ,μ_{M}]^{T},

RₘH₋ₘdiag{v₁², . . . ,vₘ₋₁²,vₘ₊₁², . . . ,v_{M}²}H₋ₘ^{H}+σ²I_{N}, (A17)

and I_{N} is an N by N identity matrix. Substituting (A16) into (A13), the LLR value under a Gaussian approximation is obtained. The complexity of computing LLR reduces from 2Σₘ₌₁^{M} Cₘ to 2^{C}^{ₘ}.

A probabilistic data association (PDA) method may be applied to uncoded MIMO systems. The concept can be extended to coded systems to compute Pr(y|xₘ). In PDA, H₋ₘx₋ₘ+w is assumed to be Gaussian with matched mean H₋ₘμ₋ₘ and covariance Rₘ in (A17). The PDA method obtains Pr(y|xₘ) as in (A16).

In iterative multiuser detection, a soft MMSE interference cancellation scheme may be used. Translating this scheme to the MIMO case, when computing the LLR, the soft estimates of all the symbols except xₘ using (A14) may be used to soft cancel the interference in y to obtain:

yₘ=y−H₋ₘμ₋ₘ. (A18)

If yₘ is used directly and assuming the interference in yₘ is Gaussian, it can be shown that Pr(y|xₘ) is given by (A16). Instead of using yₘ to generate the LLR directly, a linear MMSE filter uₘ is applied to yₘ to obtain

\hat{x}ₘ=uₘ^{H}yₘ. (A19)

where uₘ is chosen to minimize the mean-squared error between \hat{x}ₘ and xₘ, i.e.,

$${u}_{m} = arg {min}_{{w}_{m}} E \{ \vert {\hat{x}}_{m} - {x}_{m} {\vert}^{2} \} . \qquad ( A20 )$$

Using standard LMMSE estimation theory:

uₘ=\hat{R}ₘ⁻¹hₘ. (A21)

where

\hat{R}ₘ=H₋ₘdiag{v₁², . . . ,vₘ₋₁²,vₘ₊₁², . . . ,v_{M}²}H₋ₘ^{H}+hₘhₘ^{H}+σ²I_{N}=Rₘ+hₘhₘ^{H}. (A22)

Substituting (A19) into (A18):

$$\begin{matrix}{\hat{x}}_{m} = {u}_{m}^{H} ( y - {H}_{- m} {μ}_{- m} ) \\ = {u}_{m}^{H} {h}_{m} {x}_{m} + \underbrace{{u}_{m}^{H} {H}_{- m} ( {x}_{- m} - {u}_{- m} ) + {u}_{m}^{H} w}_{{η}_{m}} .\end{matrix} \qquad ( A23 )$$

If the interference ηₘ in (A23) is approximated as Gaussian:

Pr(y|xₘ)=Pr(\hat{x}ₘ|xₘ)∝exp(−(\hat{x}ₘ−uₘ^{H}hₘxₘ)^{H}(uₘ^{H}Rₘuₘ)⁻¹(\hat{x}ₘ−uₘ^{H}hₘxₘ))=exp(−(y−H₋ₘμ₋ₘ−hₘxₘ)^{H}uₘ(uₘ^{H}Rₘuₘ)⁻¹uₘ^{H}(y−H₋ₘμ₋ₘ−hₘxₘ)). (A24)

Even though (A24) may appear to be different from (A16), it can be shown that (A24) is proportional to (A16), which means that LLR values computed by using (A16) and (A24) are equal. They are not equivalent in general unless uₘ is invertible (e.g., uₘ is an M by M matrix). This is an interesting phenomenon as from the data processing lemma, the mutual information between yₘ and xₘ is greater than or equal to that between \hat{x}ₘ and xₘ.

For Gaussian signals, the linear MMSE filter does not change the mutual information. By making Gaussian assumption on the transmitted signals, it can be seen that LMMSE also preserves the LLR value even though (A16) works on a N×1 vector y and (A24) only uses a scaler \hat{x}ₘ. The approximation (A24) has a complexity advantage over (A16). In (A24), there are only two vector multiplications to obtain xₘ and uₘ^{H}hₘ and computing Pr(\hat{x}ₘ|xₘ) only involves scalar operations thereafter. On the other hand, in (A16), a vector operation is needed for each xₘ.

In MMSE equalization, the MMSE equalizer applies an affine filter on the received signal y directly (different from where the LMMSE filter is applied after canceling soft symbol estimates), i.e.,

\hat{x}ₘ=aₘ^{H}y+cₘ. (A25)

where

aₘCov(y,y)⁻¹Cov(y,xₘ)=\hat{R}ₘ⁻¹hₘ,

cₘ=E{xₘ}−aₘ^{H}E{y}=−aₘ^{H}H₋ₘμ₋ₘ. (A26)

It can be noted that E{xₘ} depends on LA(b_{i′}), ∀i′ such that Σ_{m′=1}^{m-1}C_{m′}≦i′<Σ_{m′=1}^{m}C_{m′}. As L_{A}(b_{i′}) is used after computing Pr(y|xₓ) in (A13), a priori information should not be used on xm, i.e., xₘ is assumed to be uniformly distributed over or [symbol] ₘ or E{xₘ}=0. Comparing (A26) with (A21), it can be seen that uₘ=aₘ and \hat{x}ₘ in (A25) is equal to that in (A19). Therefore, the MMSE equalizer may be equivalent, in some cases, to the soft MMSE interference cancellation.

Consequently, the processing algorithms can be considered as using a Gaussian approximation as in (A13). As such, they reduce the complexity of the LLR value, which is at the expense of performance degradation.

There are various problems associated with the existing processing algorithms as described above. For many practical wireless communications standards such as LTE, high order constellations such as 64QAM or 256 QAM have been adopted. The max-log approximation in (A10) may not work well with high order constellations as the number of terms in the summation in (A7) is large. Moreover, the LSD may be hard to implement in hardware directly due to its sequential nature.

The Gaussian approximation based algorithms avoid the max-log approximation, but the Gaussian assumption incurs some performance loss. It is noted that the performance of PDA or Gaussian approximation algorithms may not be good for higher order modulations.

To address these concerns, as well as provide other potential advantages and/or improvements, a class of non-Gaussian approximations may be used for LLR metric computation. As practical constellations have a finite alphabet structure, the non-Gaussian distribution may be integrated over a bounded set instead of from −∞ to +∞.

In another aspect, a combination of K-best algorithm and the non-Gaussian approximation may be used. In the K-best algorithm, K branches may be kept at each decoding stage and the branches may be pruned using the non-Gaussian approximation. Instead of using only the maximum of the K remaining metrics as in (A10), the sum of all the K metrics may be used to compute the LLR. The resulting algorithm may be readily parallelized in hardware.

In the subsequent embodiment examples, it is assumed that squared-QAM is used at all transmit antennas, which is the case in many wireless communications standards. However, the proposed processing method and algorithm can be readily extended to other general constellations.

With squared-QAM, (A5) can be written as a real system, i.e.,

$$\underbrace{[ \begin{matrix} ( {y}_{i} ) \\ ( {y}_{i} )\end{matrix} ]}_{{\tilde{y}}_{i}} = \underbrace{[ \begin{matrix} ( {H}_{i} ) & - ( {H}_{i} ) \\ ( {H}_{i} ) & ( {H}_{i} )\end{matrix} ]}_{{\tilde{H}}_{i}} \underbrace{[ \begin{matrix} ( {x}_{i} ) \\ ( {yx}_{i} )\end{matrix} ]}_{{\tilde{x}}_{i}} + \underbrace{[ \begin{matrix} ( {w}_{i} ) \\ ( {w}_{i} )\end{matrix} ]}_{{\tilde{w}}_{i}} , \\ i = 0 , … , {N}_{s} - 1 , \qquad ( A27 )$$

where Y(x) and T(x) denote the real part and imaginary part of x, respectively and the entries of \tilde{x}ᵢ are from PAM constellations. With a slight abuse of notations, (A5) may still be used to represent the real system (A27) as follows, with the entries of xᵢ from PAM.

As described previously herein, to motivate a non-Gaussian approximation, we may start with a BPSK constellation, i.e., X 0{+1, −1}. Let Pr(X=+1)=p and Pr(X=−1)=1−p. This probability mass function (puff) may be written as a single equation as:

$$Pr ( X = x ) = {{p}^{{( \frac{x + 1}{2} )}^{2}} ( 1 - p )}^{{( \frac{x + 1}{2} )}^{2}} , x = \pm 1. \qquad ( A28 )$$

A continuous approximation to this pmf may be generated by relaxing x to be a real number with a scaling factor to keep ∫Pr(X=x)dx=1. It is noted that there are several choices of the pmf (A28). For example, we can choose

$$Pr ( X = x ) = {{p}^{\frac{x + 1}{2}} ( 1 - p )}^{\frac{1 - r}{2}} .$$

However, this function will go to ∞ when x goes to ∞, which is undesired.

$$Pr ( X = x ) = {{p}^{\frac{\vert x + 1 \vert}{2}} ( 1 - p )}^{{ }^{\frac{\vert x - 1 \vert}{2}}}$$

may also be chosen, however, this function is hard to obtain in a closed form form integration.

This approach may be extended to higher order modulations. In general, for a given modulation [symbol] with Pr(X=xᵢ)=pi and 3pᵢ=1, the pmf may be written in a single equation as:

$$\begin{matrix}Pr ( X = x ) = {\prod }_{{x}_{i} ∈}^{ } {p}_{i}^{\frac{{\prod }_{{x}_{j} ∈}^{ } {( x - {x}_{j} )}^{2}}{{\prod }_{{x}_{j} ∈}^{ } {( {x}_{i} - {x}_{j} )}^{2}}} , x ∈ \\ = exp ( {\sum }_{l = 0}^{2 ( \vert \vert - 1 )} {a}_{l} {x}^{l} ) .\end{matrix} \qquad ( A29 )$$

A pdf approximation may be obtained by relaxing x to be a real number. When a | [symbol] >2, if (A29) is used directly in (A16), the integral involves a polynomial greater than second order in the exponential function, whose closed form may be difficult to obtain. Therefore, the pmf (A29) may be approximated with a second order polynomial in the exponential function for any [symbol] i.e.,

Pr(X=x)=exp(−(c+2rx+ax²)). (A30)

It is noted that the Gaussian distribution is a special case of (A30), which contains only two variables. The coefficients a, r, c may be found by solving:

$$\begin{matrix}{min}_{a , r , c} {\sum }_{i}^{ } {{ω}_{i} ( exp ( - ( c + 2 {rx}_{i} + {ax}_{i}^{2} ) ) - {p}_{i} )}^{2} , or & ( A31 ) \\ {min}_{a , r , c} {\sum }_{i}^{ } {{ω}_{i} ( c + 2 {rx}_{i} + {ax}_{i}^{2} + log ( {p}_{i} ) )}^{2} , & ( A32 )\end{matrix}$$

where ωᵢ≦0 is a weight for symbol xᵢ. In practical systems, only symbols with the largest probability may be considered. In this case, we may choose ωᵢ=1 for the three largest probability symbols and ωᵢ₌0 otherwise. The solution of (A32) can be readily obtained by a least squares approach.

However, as noted previously, a Gaussian approximation may not be good for some pmfs, and the integration in (A16) is from −∞ to +∞, which may distort the LLR value. It is noted that practical constellations typically are usually finite alphabets, e.g., 2D-PAM is {−2D+1,−2D+3, . . . ,2D−3,2D−1}. The integration range may be bounded, for example by integrating from −U to U instead. Possible choices of U include 2D or 2D−1+σ.

When U=2D, Pr (X=d) may be approximated by the integral between d−1 and d+1. When U=2D−1+σ, Pr(X=d) may be approximated similarly as when U=2D but taking into account of the noise variance at the two boundary points. With (A30) and the finite integration, (A16) can be written as:

$$\begin{matrix}Pr ( y \vert {x}_{m} ) ∝ {\int }_{- U}^{+ U} exp ( \begin{matrix}- \frac{{‖ y - {H}_{- m} {x}_{- m} - {h}_{m} {x}_{m} ‖}^{2}}{{σ}^{2}} - \\ 2 {r}_{- m}^{T} {x}_{- m} - {x}_{- m}^{T} {A}_{- m} {x}_{- m}\end{matrix} ) d {x}_{- m} \\ ∝ exp ( - \frac{{‖ y - {h}_{m} {x}_{m} ‖}^{2}}{{σ}^{2}} ) \\ {\int }_{- U}^{+ U} exp ( \begin{matrix}- 2 {\underbrace{( \begin{matrix}{r}_{- m}^{T} - \frac{1}{{σ}^{2}} \\ {( y - {h}_{m} {x}_{m} )}^{T} {H}_{- m}\end{matrix} )}}_{{b}_{- m}^{T}} {x}_{- m} - \\ {x}_{- m}^{T} {\underbrace{( {A}_{- m} + \frac{{H}_{- m}^{T} {H}_{- m}}{{σ}^{2}} )}}_{{R}_{m}} {x}_{- m}\end{matrix} ) d {x}_{- m}\end{matrix} \qquad ( A33 )$$

where r₋ₘ=[r₁, . . . ,rₘ₋₁,rₘ₊₁, . . . ,r_{M}]^{T} and A₋ₘ=diag{a₁, . . . ,aₘ₋₁,aₘ₊₁, . . . ,a_{M}}, r_{m′}, and a_{m′} may be obtained from (A31) and (A32). Comparing with (A16), it may be noted that there are two main differences. First, r₋ₘ and A₋ₘ are not from the matched mean and variance but from matching the pmf directly. Second, the integral is from −U to U.

To compute the integral in (A33), we may let the singular value decomposition of Rₘ be V^{T} ΛV and g(xₘ)=Vb₋ₘ, where Λ=diag{λ₁, . . . ,λ_{M-1}}, making a change of variables by defining z=Vx₋ₘ. However, the integration region of z′ is a M−1 dimensional polytope, which makes the integral difficult to compute. For simplicity, the integration region may be enlarged by setting a bound Zᵢ=UΣⱼ₌₁^{M-1}|V_{i,j}| for dimension i. (A33) may then be upper bounded as:

$$Pr ( y \vert {x}_{m} ) ∝ exp ( - \frac{{‖ y - {h}_{m} {x}_{m} ‖}^{2}}{{σ}^{2}} ) {\prod }_{i = 1}^{M - 1} {\int }_{- {Z}_{i}}^{+ {Z}_{i}} exp ( - 2 {g}_{i} ( {x}_{m} ) {z}_{i} - {λ}_{i} {z}_{i}^{2} ) d {z}_{i} . \qquad ( A34 )$$

It is noted that the second product in (A34) also depends on xₘ. In some cases, λi may be negative. Therefore, the integral cannot be written into Q-function.

To illustrate the difference between Gaussian approximation and non-Gaussian approximation (as was similarly described previously herein), an example may be considered. Using, for the example a 4-PAM constellation where [symbol] ={−3,−1,1,3}. Two bits (b₁,b₂) may be mapped to [symbol] via gray mapping (0,1)→−3,(0,0)→−1,(1,0)→1,(1,1)→3. Let Pr(b₁=1)=0.6 and Pr(b₂=1)=0.8. This results in Pr(X=−3)=0.32, Pr(X=−1)=0.08, Pr(X=1)=0.12, and Pr(X=3)=0.48. The pdf of non-Gaussian and Gaussian approximations may be compared, such as described previously herein, where the parameters in non-Gaussian are obtained using (A32).

The areas between 2i and 2i−2, i=−1,0,1,2 are 0.3130, 0.0906, 0.1049, 0.4915 for the non-Gaussian approximation and 0.1480, 0.2909, 0.3348, 0.2263 for the Gaussian approximation. It is apparent that the Gaussian approximation does not match the discrete distribution when some bits are not reliable. This problem is especially severe when each symbol contains more than 2 bits. This may be a reason why the performance of PDA is not good for high order modulations. Note that in this case a<0 in (A30).

For general bit mappings, due to the constraint on the polynomial order, (A30) may not fit the pmf for all symbols in large constellations. It is noted that Gray mapping does not perform well in iterative joint detection and decoding. Other mappings such as set partitioning mapping have better performance. For set partitioning mapping, the polynomial order constraint may be resolved via constellation decomposition. For example, let bᵢ=+1 for logical one and bᵢ=−1 for logical zero. The set partitioning mapping for 2^{C}-PAM ( [symbol] ={−2^{C}+1,−2^{C}+3, . . . ,2^{C}−3,2^{C}−1}) may be written as:

$$x = {\sum }_{i = 0}^{C - 1} {2}^{i} {b}_{i} = {d}^{T} b . \qquad ( A35 )$$

where d=[1,2, . . . ,2^{C-1}]^{T} and b=[b₀, . . . ,b_{C-1}]^{T}. It is noted that the scaling factor in the modulation has been ignored to keep unit average power. As each entry of b takes BPSK, the continuous approximation to the pmf is given in (A28).

We may define \tilde{H}_{-\dot{m}}=H₋ₘdiag{d₁^{T}, . . . ,dₘ₋₁^{T},dₘ₊₁^{T}, . . . ,d_{M}^{T}} and b₋ₘ=[b₁^{T}, . . . ,bₘ₋₁^{T},bₘ₊₁^{T}, . . . ,b_{M}^{T}]^{T}. By replacing H₋ₘ with \tilde{H}₋ₘ and x₋ₘ with b₋ₘ in (A33), a similar form as (A34) may be obtained. The only difference is that the new eigenvalue \tilde{λ}ᵢ is nonnegative. Therefore, (A34) may be rewritten as:

$$Pr ( y \vert {x}_{m} ) ∝ exp ( - \frac{{‖ y - {h}_{m} {x}_{m} ‖}^{2}}{{σ}^{2}} + {\sum }_{i = 1}^{M - 1} \frac{{\overline{g}}_{i}^{2} ( {x}_{m} )}{{λ}_{i}} ) \times {\prod }_{i = 1}^{M - 1} ( Q ( \sqrt{2 {\hat{λ}}_{i}} {Z}_{i} + \sqrt{\frac{2}{{\hat{λ}}_{i}}} {\dot{g}}_{i} ( {x}_{m} ) ) - Q ( - \sqrt{2 {\hat{λ}}_{i}} {Z}_{i} + \sqrt{\frac{2}{{\hat{λ}}_{i}}} {\dot{g}}_{i} ( {x}_{m} ) ) ) . \qquad ( A36 )$$

where Ā−ₘ and \tilde{r}−ₘ are defined similarly as \tilde{H}−_{m.} This approach may be extended to other similar bit mappings resulting in constellation partitioning.

In various embodiments, an a priori K-best processing implementation may be used in computing an LLR value to provide potential performance and/or efficiency advantages. It is noted that the LSD only considers the maximum term among all the 2Σₘ₌₁^{M}C_{M-1} terms in (A7), and the list is generated by using Pr(y|x₁, . . . ,x_{M}) only without using the a priori information Pr(x_{m′}), m′=1, . . . ,M. Moreover, when the LSD comes to the i-th data stream, it only checks the symbols satisfying:

$${( {\tilde{y}}_{i} - {R}_{i , j} {x}_{i} - {\sum }_{j = i + 1}^{M} {R}_{i , j} {\tilde{x}}_{j} )}^{2} + {\sum }_{j = i + 1}^{M} {( {\tilde{y}}_{j} - {\sum }_{l = i}^{M} {R}_{j , l} {\tilde{x}}_{l} )}^{2} \leq {r}^{2} \text{:} \qquad ( A37 )$$

where the QR decomposition of H is H=QR, Rᵢⱼ is the (i,j)-th entry of R, \tilde{y}=Q^{H}y and \tilde{x}ⱼ is the trial value of xⱼ. Using (A37) does not consider the effect of choosing xᵢ on the data streams 1, . . . ,i−1. On the other hand, the Gaussian approximation algorithm described previously considers the summation in (A7) but the Gaussian approximation is not good for high order constellations.

Accordingly, a processing implementation using both approached may be used. In particular, a Gaussian approximation and/or a non-Gaussian approximation may be used as a metric to guide the K-best list search, taking into account the effects of stream i on streams 1, . . . ,i−1.

As with an LSD implementation, it may also be desirable to find a list of K lattice points. However, distinct from LSD, it may be desirable to try to find a list L_{i,±1}, containing K points for each bᵢ₌±1. The LLR value of the bit bᵢ in (A7) may then be approximated as:

$$L ( {b}_{i} \vert y ) \approx log \frac{{\sum }_{x ∈ = {i , + 1}_{}}^{ } Pr ( x \vert y )}{{\sum }_{x ∈ {i , - 1}_{}}^{ } Pr ( x \vert y )} . \qquad ( A38 )$$

Another difference from the LSD approach may be using a sum-log approach rather than a max-log approach. Yet another difference relates to how the list is generated. For example, it may be desirable to find K lattice points x∈X_{i,±1} such that Pr(x|y) is maximized, rather than Pr(y|x) is maximized, where the a priori information is exploit in the former case.

There are several ways to generate the list using modified K-best algorithm—these may be denoted as \tilde{x}ₘ∈X_{i,±1}^{m} sum-algorithm and max-algorithm. In the sum-algorithm approach, at the initial step, Pr(\tilde{x}ₘ|y) assuming that bᵢ belongs to data stream m, we may first cheek each to find the K candidates such that Pr(xₘ|y) is maximized and add m into a set V. This can be written as:

$$Pr ( {\tilde{x}}_{m} \vert y ) = {\sum }_{{x}_{- m}}^{ } Pr ( {x}_{- m} , {\tilde{x}}_{m} \vert y ) ∝ {\sum }_{{x}_{- m}}^{ } Pr ( y \vert {x}_{- m} , {\tilde{x}}_{m} ) Pr ( {x}_{- m} ) . \qquad ( A39 )$$

Direct computation of (A39) requires summation, which may be 2Σₘ₌₁^{M}Cₘ₋₁ computationally prohibitive. As described previously, the summation in (A39) may be replaced by an integral as:

Pr(\tilde{x}ₘ|y)∝∫Pr(y|x₋ₘ,\tilde{x}ₘ)f(x₋ₘ)dx₋ₘ. (A40)

Where f(x₋ₘ) is the matched pdf of x₋ₘ, which could be either Gaussian or non-Gaussian. For example, with a Gaussian approximation:

Pr(\tilde{x}ₘ|y)∝exp(−(y−H₋ₘμ₋ₘ−hₘ\tilde{x}ₘ)^{H}Rₘ⁻¹(y−H₋ₘμ₋ₘ−hₘ\tilde{x}ₘ)) (A41)

where μ₋ₘ and Rₘ K \tilde{x}ₘ are defined Pr(\tilde{x}ₘ|y) in (A41). The largest may be added into a list [symbol] , which may be initialized to be Ø.

The processing may then go to xⱼ, j≠m x₁,x₂, . . . ,x_{M}. Before it reaches the end, we may have V={m,1, . . . ,j−1} and the list [symbol] contains K candidates, each of which has the form xᵥ=[xₘ,x₁, . . . ,xⱼ₋₁]^{T}.

For each xᵥ∈ [symbol] , we may then compute Pr(xᵥ,\tilde{x}ⱼ|y) for each \tilde{x}ⱼ∈ [symbol] ⱼ. Among the resulting K| [symbol] ⱼ| [xᵥ^{T},\tilde{x}ⱼ]^{T}, we may only choose K of them such that Pr(xᵥ,\tilde{x}ⱼ|y) is maximized, update the list [symbol] with the K chosen vectors, and add j into V. Pr(xᵥ,\tilde{x}ⱼ|y) may be approximated in the same manner as in equation (A40). In the case of use of Gaussian approximation, we have:

Pr(xᵥ,\tilde{x}ⱼ|y)∝exp(−(y−H_{-{v j}}μ_{-{v j}}−Hᵥxᵥ−hⱼ\tilde{x}ⱼ)^{H}R_{{v j}}⁻¹(y−H_{-{v j}}μ_{-{v j}}−Hᵥxᵥ−hⱼ\tilde{x}ⱼ)). (A42)

where μ−A constitutes the entries of μ that are not in A, H_{-A} is consisted of the columns of H that are not in A and

R_{{v,j}}=H_{-{v,j}}diag{v_{-{v,j}}²}H_{-{v,j}}^{H}+σ²I_{N}. (A43)

The processing then ends when j=M.

In another implementation using the max processing algorithm, where Pr(xᵥ,\tilde{x}ⱼ|y) is maximized consecutively, Pr(\tilde{x}|y) may be maximized directly. At the first step, for each \tilde{x}ₘ∈,X_{m±1}^{m}, the corresponding \tilde{x}₋ₘ may be found such that:

$$\begin{matrix}{\tilde{x}}_{- m} = arg {max}_{{x}_{- m} ∈ {X}^{- m}} Pr ( {\tilde{x}}_{m} , {x}_{- m} \vert y ) \\ = arg {max}_{{x}_{- m} ∈ {X}^{- m}} Pr ( {\tilde{x}}_{m} , {x}_{- m} ) Pr ( {\tilde{x}}_{m} , {x}_{- m} ) .\end{matrix} \qquad ( A44 )$$

where X^{-m} includes all possible lattice points. K \tilde{x}ₘ may be put into the list [symbol] such that Pr(\tilde{x}ₘ,\tilde{x}₋ₘ|y) is largest and add m into a set V. As solving (A44) has a high computation complexity, Pr(\tilde{x}ₘ,x₋ₘ) may be replaced with a continuous Gaussian or non-Gaussian approximation, and the discrete set X^{-m} into a continuous set C^{-m}.

When C^{-m} is bounded, the boundary on xⱼ is defined by the largest and smallest elements in [symbol] . For example, when [symbol] ={−3,−1,1,3}, −3≦xⱼ≦3 may be chosen. When the non-Gaussian approximation in (A30) is used, (A45) needs to be solved:

$${\tilde{x}}_{- m} = arg {min}_{{x}_{- m} ∈ {C}^{- m}} {‖ y - {H}_{- m} {x}_{- m} - {h}_{m} {\tilde{x}}_{m} ‖}^{2} + 2 {σ}^{2} {r}_{- m}^{T} {x}_{- m} + {σ}^{2} {x}_{- m}^{T} {A}_{- m} {x}_{- m} . \qquad ( A45 )$$

As (A45) is quadratic in x₋ₘ, when the objective function of (A45) is convex, \acute{x}₋ₘ may be found using convex optimization methods. If not, a local minimum around the following may be found:

$$arg {min}_{{x}_{- m} ∈ {C}^{- m}} {‖ y - {H}_{- m} {x}_{- m} - {h}_{m} {\tilde{x}}_{m} ‖}^{2} .$$

\tilde{x}₋ₘ=\hat{x}₋ₘ or map \grave{x}₋ₘ may be set to the closest lattice point in X^{-m}. Comparing with (A37), (A45) uses the a priori information through r₋ₘ and A₋ₘ and its counts the effect of symbol \tilde{x}ₘ on Pr(\tilde{x}ₘ,\tilde{x}₋ₘ|y).

The process may then go to x₁,x₂, . . . ,x_{M}, before it reaches xⱼ, j≠m. V={m, 1, . . . ,j−1} and the list [symbol] contains K candidates, each of which has the form xᵥ=[xₘ,x₁, . . . ,xⱼ₋₁]^{T}. For each \tilde{x}ᵥ∈ [symbol] and each \tilde{x}ⱼ∈ [symbol] ⱼ, we may find the corresponding \tilde{x}_{-{v,j}} such that:

$${\tilde{x}}_{- \{ v {,}_{j} \}} = arg {max}_{{x}_{- \{ v {,}_{j} \}} ∈ {X}^{- ( v {,}_{j} \}}} Pr ( {\tilde{x}}_{v} , {\tilde{x}}_{j} , {x}_{- \{ v {,}_{j} \}} \vert y ) . \qquad ( A46 )$$

Among the resulting K| [symbol] ⱼ| [\tilde{x}ᵥ^{T},\tilde{x}ⱼ]^{T}, we may only choose K of them such that Pr(\tilde{x}ᵥ,\tilde{x}ⱼ,\tilde{x}_{-{v,j}}|y) is maximized, update the list [symbol] with the K chosen vectors and add j into V.

As in (A45), \tilde{x}₋ₘ may be approximated by solving:

$${\tilde{x}}_{- \{ v {,}_{j} \}} = arg {min}_{{x}_{- \{ v {,}_{j} \}} ∈ {C}^{- \{ v {,}_{j} \}}} {‖ y - {H}_{- \{ v {,}_{j} \}} {x}_{- \{ v {,}_{j} \}} - {H}_{v} {\tilde{x}}_{v} {h}_{j} {\tilde{x}}_{j} ‖}^{2} + 2 {σ}^{2} {r}_{- \{ v {,}_{j} \}}^{T} {x}_{- \{ v {,}_{j} \}} + {σ}^{2} {x}_{- \{ v {,}_{j} \}}^{T} {A}_{- \{ v {,}_{j} \}} {x}_{- \{ v {,}_{j} \}} . \qquad ( A47 )$$

where the notations are similar to those in (A42) and (A45).

It is noted that the difference between the sum-algorithm and the max-algorithm lies in the fact that the effects of x_{-{v,j}} are removed from Pr(\tilde{x}ᵥ,\tilde{x}ⱼ,x_{-{v,j}}|y) by summing over all possible x_{-{v,j}} in the former case while we take the max x_{-{v,j}} maximizing this probability in the latter case. When C^{-m} is unbounded and Gaussian approximation is used, it is can be seen that solving (A44) is equivalent to solving:

$${min}_{{x}_{- m} ∈ {C}^{- m}} {‖ y - {H}_{- m} {x}_{- m} - {h}_{m} {\tilde{x}}_{m} ‖}^{2} + {( {x}_{- m} - {μ}_{- m} )}^{H} {A}_{- m} ( {x}_{- m} - {μ}_{- m} ) . \qquad ( A48 )$$

where Λ₋ₘ=diag{v₁², . . . ,vₘ₋₁²,vₘ₊₁², . . . ,v_{M}²}.

The basic algorithms can also be extended in various ways. Some examples of these variations are described below.

Common List Algorithm: Using the two basic list algorithms, two lists (one for +1 and the other for −1) for each bit's LLR computation need to be found. When the total number of bits is large, this may incur a high computational complexity. To reduce the complexity, the same list [symbol] may be used for all bits' LLR computation. The list may be generated by choosing the K lattice points such that Pr(x|y) is maximized. Both the sum-algorithm and the max-algorithm can be used for this purpose. Different from the basic algorithms which start from xₘ, we may start from x₁ to x₂, . . . in the common list algorithm, where xⱼ is from [symbol] ⱼ ∀j={1, . . . ,M}. Finally, the LLR value of the bit bᵢ is then approximated as:

$$L ( {b}_{i} \vert y ) \approx log \frac{{\sum }_{x ∈ {χ}_{1 , + 1} ⋂ ℒ} Pr ( y \vert x ) Pr ( x )}{{\sum }_{x ∈ {χ}_{1 , - 1} ⋂ ℒ} Pr ( y \vert x ) Pr ( x )} . \qquad ( A49 )$$

When x∈X_{i±1}∩ [symbol] =Ø, the LSD in [4] proposes using a predetermined saturated LLR value ±B, e.g., B=8. We propose using Σₓ_{ₘ}_{∈x}_{ₘ₌₁}_{^{m}}Pr(xₘ)Pr(y|xₘ) with Gaussian or non-Gaussian approximation for Pr(y|xₘ) or using:

$${max}_{x ∈ {C}_{i , \pm } 1} Pr ( x ) Pr ( y \vert x ) , \qquad ( A50 )$$

where C_{i,±1} is the real relaxation of X_{i,±1}.

Parallel Algorithm: In the basic algorithms, the list is generated by visiting xₘ,x₁, . . . ,x_{M}, sequentially. We can also generate the list in parallel by generating a list [symbol] ᵢ for each xᵢ, where [symbol] ᵢ is generated by choosing the best Ki elements in Qi to maximize Pr(xᵢ|y). In this case, the list is given by [symbol] = [symbol] ₁× [symbol] ₂× . . . × [symbol] _{M}, which is of size K=Πᵢ₌₁^{M}Kᵢ. Using this approach, different lists [symbol] ᵢ can be generated in parallel, which is suitable for hardware implementation.

Bit-wise Algorithm: The basic algorithms proceed from symbol to symbol. However, both algorithms can also run on bits. For example, when set partitioning mapping is used, as shown in equation (A35), the 2C-PAM can be written as a weighted sum of bits. Both algorithms can work on bits by replacing x in both algorithms with b using (A35).

Bit-wise algorithms can also be derived for arbitrary mappings. The sum-algorithm may be considered as an example. To compute L(bᵢ|y), we may start with bᵢ and compute Pr(bᵢ=±1|y)=Σ_{x∈}x_{i,-1}Pr(x|y). In (A40), every xⱼ except xₘ may be replaced with a Gaussian or non-Gaussian continuous variable and Pr(bi=±1|y) may be computed by summing over all possible xₘ in X_{i,±1}^{m}, xₘ may also be approximated as a continuous variable. For example, when xₘ is assumed to be Gaussian, the matched mean and variance may be determined as:

$$\begin{matrix}{μ}_{m , i , \pm 1} = {\sum }_{{x}_{m} ∈ {χ}_{i , \pm 1}^{m}} Pr ( {x}_{m} ) {x}_{m} \\ and & ( A51 ) \\ {v}_{m , i , \pm 1}^{2} = {\sum }_{{x}_{m} ∈ {χ}_{i , \pm 1}^{m}} Pr ( {x}_{m} ) {\vert {x}_{m} \vert}^{2} - {\vert {μ}_{m , i , \pm 1} \vert}^{2} . & ( A52 )\end{matrix}$$

When the non-Gaussian distribution is used, the distribution may be obtained by fitting the distribution over the symbols in X_{i,±1}^{m} only. The probability Pr(bi|y) may be obtained as in (A41). When the algorithm reaches bit bⱼ and its corresponding symbol is x_{m′}, where symbols x_{m′+1}, . . . ,xₘ₋₁,xₘ₊₁, . . . ,x_{M} have not been visited. For example, let bⱼ=[b₁, . . . ,bⱼ,bᵢ]^{T}. For any \tilde{b}ⱼ from the list [symbol] , we can compute the matched mean and variance for x_{m′} as

$$\begin{matrix}{μ}_{{m}^{′} , {b}_{j} , {\overline{b}}_{j}} = {\sum }_{{x}_{{m}^{′}} ∈ {χ}_{{b}_{j} , {\overline{b}}_{j}}^{{m}^{′}}} Pr ( {x}_{{m}^{′}} ) {x}_{{m}^{′}} \\ and & ( A53 ) \\ {v}_{{m}^{′} , {b}_{j} , {\overline{b}}_{j}}^{2} = {\sum }_{{x}_{{m}^{′}} ∈ {χ}_{{b}_{j} , {\overline{b}}_{j}}^{{m}^{′}}} Pr ( {x}_{{m}^{′}} ) {\vert {x}_{m} \vert}^{2} - {\vert {μ}_{{m}^{′} , {b}_{j} , {\overline{b}}_{j}} \vert}^{2} , & ( A54 )\end{matrix}$$

where X_{bj,\tilde{b}\tilde{j}}^{m′}, is the set of constellation points for x_{m′} such that the corresponding bits in bj is equal to \tilde{b}ⱼ. The rest of the algorithm may be implemented in a fashion the same as or similar to that of the symbol based algorithm.

A potential advantage of the bit-wise algorithm is that some symbols may be pruned early when the first few bits of the corresponding symbols are not chosen in the list with K elements.

Early Stopping and Varied K: As described above, the basic algorithms generally stop after reaching xₘ. However, we may stop the algorithm at any xⱼ. In this case, the LLR value may be determined as:

$$\text{?} \approx log \frac{\text{?} Pr ( {x}_{1} , … , {x}_{j} , {x}_{m} ) \text{?} Pr \text{?} Pr ( y \vert x )}{\text{?} Pr ( {x}_{1} , … , {x}_{j} , {x}_{m} ) \text{?} Pr \text{?} Pr ( y \vert x )} \\ {\sum }_{{x}_{j + 1} , … , {x}_{m - 1} , {x}_{m + 1} , … , {x}_{M}} Pr ( {x}_{j + 1} , … , {x}_{m - 1} , {x}_{m + 1} , … , {x}_{M} ) Pr ( y \vert x ) \\ \text{?} \text{indicates text missing or illegible when filed} \qquad ( A55 )$$

may then be approximated by using a Gaussian or non-Gaussian approximation. The stopping level gives a tradeoff between performance and complexity. Early stopping may also be used when some symbols are not reliable, e.g., every symbol in the constellation has roughly the same probability. In this case, different candidates may have roughly the same metric. Choosing the best K candidates may not be good. The symbols may be reordered such that the unreliable symbols correspond to the last few symbols, and early stopping may be used when the algorithm reaches the unreliable symbols

The list size K may also be varied for different symbols. The list size Kⱼ may be chosen as Kⱼ after symbol xⱼ is visited. For example, Kⱼ can be chosen to be a large value for the first few visited symbols as the choice of these symbols is important to the overall performance, and Kⱼ is chosen to be a small value when the algorithm is close to the end to save complexity.

In practical protocols there always exists some CRC check bits. When a particular data stream passes the CRC check, this data stream does not need to be included in the future iterative demodulation and decoding. For example, this data stream may be cancelled directly or using hard SIC.

Some aspects of the disclosure related to complexity reduction, such as described previously herein with respect to matrix inversion. As noted previously, direct computation of (A42) or equation (4) requires matrix inversion and matrix multiplication for every \tilde{x}ⱼ∈ [symbol] ⱼ. From the expression of R_{{v,j}} in (43) and the matrix inversion lemma, we have:

$$\begin{matrix}{R}_{\{ v , j \}}^{- 1} = {( {R}_{v} + {v}_{j}^{2} {h}_{j} {h}_{j}^{H} )}^{- 1} \\ = {R}_{v}^{- 1} - {R}_{v}^{- 1} {{h}_{j} ( {v}_{j}^{- 2} + {h}_{j}^{H} {R}_{v}^{- 1} {h}_{j} )}^{- 1} {h}_{j}^{H} {R}_{v}^{- 1} \\ = {R}_{v}^{- 1} - {{g}_{j} ( {v}_{j}^{- 2} + {h}_{j}^{H} {g}_{j} )}^{- 1} {g}_{j}^{H} .\end{matrix} \qquad ( A56 )$$

where gⱼ=Rᵥ⁻¹hⱼ. Initially, we need to compute (Hdiag{v²}H^{H}+σ²I_{N})⁻¹, which has a complexity O(N^{2.376}+NM²). Substituting (A56) into (A42), we obtain:

$${( y - \text{?} - {H}_{v} {x}_{v} - {h}_{j} {\tilde{x}}_{j} )}^{H} {R}_{\{ v , j \}}^{- 1} ( y - \text{?} - {H}_{v} {x}_{v} - {h}_{j} {\tilde{x}}_{j} ) = {( y - \text{?} {H}_{v} {x}_{v} - {h}_{j} {\tilde{x}}_{j} )}^{H} ( {R}_{v}^{- 1} - {{g}_{j} ( {v}_{j}^{- 2} + {h}_{j}^{H} {g}_{j} )}^{- 1} {g}_{j}^{H} ) \times ( y - \text{?} - {H}_{v} {x}_{v} - {h}_{j} {\tilde{x}}_{j} ) = {y}^{H} {R}_{v}^{- 1} y - {y}^{H} {{g}_{j} ( {v}_{j}^{- 2} + {h}_{j}^{H} {g}_{j} )}^{- 1} {g}_{j}^{H} y - 2 {\tilde{x}}_{j} {h}_{j}^{H} ( {R}_{v}^{- 1} - {{g}_{j} ( {v}_{j}^{- 2} + {h}_{j}^{H} {g}_{j} )}^{- 1} {g}_{j}^{H} ) ( y - \text{?} + {h}_{j} {μ}_{j} - {H}_{v} {x}_{v} ) + {\tilde{x}}_{j}^{2} {h}_{j}^{H} ( {R}_{v}^{- 1} - {{g}_{j} ( {v}_{j}^{- 2} + {h}_{j}^{H} {g}_{j} )}^{- 1} {g}_{j}^{H} ) {h}_{j} = {\underbrace{{y}^{H} {R}_{v}^{- 1} y - {y}^{H} {{g}_{j} ( {v}_{j}^{- 2} + {h}_{j}^{H} {g}_{j} )}^{- 1} {g}_{j}^{H} y}}_{C} - 2 {\tilde{x}}_{j} {\underbrace{( 1 - {h}_{j}^{H} {{g}_{j} ( {v}_{j}^{- 2} + {h}_{j}^{H} {g}_{j} )}^{- 1} ) {g}_{j}^{H} ( y - \text{?} + {h}_{j} {μ}_{j} - {H}_{v} {x}_{v} )}}_{B} + {\tilde{x}}_{j}^{2} {\underbrace{( {h}_{j}^{H} {g}_{j} - {h}_{j}^{H} {{g}_{j} ( {v}_{j}^{- 2} + {h}_{j}^{H} {g}_{j} )}^{- 1} {g}_{j}^{H} {h}_{j} )}}_{A} \\ \text{?} \text{indicates text missing or illegible when filed} \qquad ( A57 )$$

Computing hⱼ^{H}gⱼ and gⱼ^{H}y need 2(N−1) additions and 2N multiplications. y^{H}Rᵥ⁻¹y and y−H₋ᵥμ₋ᵥ are inherited from the previous step. Hᵥxᵥ is updated and stored in the list and the update needs KN multiplications and KN additions. Computing y−H₋ᵥμ₋ᵥ+hⱼμⱼ−Hᵥxᵥ needs N multiplications and 2N additions.

The total number of additions to compute the coefficients A,B,C for all the elements in the list is 3(K+1)N+K−2 and the total number of multiplications is (2K+3)N+5. As equation (A57) is a scalar function in \tilde{x}ⱼ, we can search over [symbol] ⱼ for each xᵥ to find the K candidates with the maximum (A42). This algorithm requires 2K| [symbol] ⱼ| multiplications and 2K| [symbol] ⱼ| additions, thereby reducing computation complexity.

Another implementation tries to find κ \tilde{x}ⱼ that maximizes (A57) for each xᵥ, e.g., κ=4. The list may be updated from the resulting κK candidates. To find the best κ for (A57), properties of the second order polynomial may be used as follows.

Let l be the index of a constellation point in [symbol] that is closest to B/A. If B/A> [symbol] ⱼ(l), the best κ \tilde{x}ⱼ are simply [symbol] ⱼ(l), [symbol] ⱼ(l+1), [symbol] ⱼ(l−1), [symbol] ⱼ(l+2), . . . If B/A< [symbol] ⱼ(l), the best κ \tilde{x}ⱼ are [symbol] ⱼ(l), [symbol] ⱼ(l−1), [symbol] ⱼ(l+1), [symbol] ⱼ(l−2), . . . The total complexity of the basic sum-algorithm is O(N^{2.376}+Σₘ₌₁^{M}CₘK(MN+κ)+NM²). When a common list is used, the complexity becomes O(N^{2.376}+K(MN+κ)+NM²).

Some aspects of the disclosure relate to channel inversion as may be applied in MIMO-OFDM. As described previously, the complexity of computing (Hdiag{v²}H^{H}+σ²I_{N})⁻¹ consists of a large portion of the total complexity. In MIMO-OFDM, different subcarrier have different channels H, which generally need to be computed for each subcarrier. Moreover, each iteration between the demodulator and the decoder gives a new v² and this matrix inversion needs to be computed for each iteration.

To reduce the complexity of matrix inversion computation, v² may be replaced with a 0-1 vector ξ, when vⱼ² is greater than a threshold (e.g., 0.5) choose ξⱼ=1, and ξⱼ=0 otherwise. When vⱼ² is large the symbol is not reliable and we may assume the symbol is uniformly distributed which results in ξj=1. On the other hand, when vⱼ² is small, the symbol is reliable and we may use hard decision on this symbol resulting in ξj=0. Therefore, from (A56), (HᵢHᵢ^{H}+σ²I_{N})⁻¹ only needs to be computed at the i-th subcarrier.

In MIMO-OFDM systems, adjacent subcarriers have similar Hᵢ and hence similar (HᵢHᵢ^{H}+σ²I_{N})⁻¹. This correlation may be used to reduce the complexity of computing the matrix inversion. For example, when the channels between each transmit and receive antenna are flat fading, all Hᵢ are identical and the matrix inversion need be computed only once, reducing the complexity by a factor of Nₛ.

For example, let γ=max_{m,n,l}┌τ_{n,m,l}/Tₛ┘ in (A4). Each entry of Ξᵢ=HᵢHᵢ^{H}+σ²I_{N}is a polynomial in

$${e}^{- j \frac{2 π}{{N}_{p}} i}$$

of order at most 2γ. The inverse of Ξᵢ is

$${Ξ}_{i}^{- 1} = \frac{adj ( {Ξ}_{i} )}{det ( {Ξ}_{i} )} , \qquad ( A58 )$$

where adj (Ξᵢ) is the adjugate of Ξᵢ, the matrix formed by the cofactors of Ξᵢ. From the definition of adjugate matrix and determinant, each entry of adj (Ξᵢ) and det (Ξᵢ) are polynomials in

$${e}^{- j \frac{2 π}{{N}_{p}} i}$$

of order at most 2γ(N−1) and 2γN, respectively. If adj(Ξᵢ) and det(Ξᵢ) are computed on subcarriers in [symbol] and | [symbol] |≧2γN, we can determine the coefficients of these polynomials and Ξᵢ⁻¹ at subcarriers not in [symbol] can be obtained by substituting

$${e}^{- j \frac{2 π}{{N}_{p}} i}$$

into the polynomials corresponding to adj(Ξᵢ) and det(Ξᵢ), which is a form of interpolation.

However, the complexity of computing adj(Ξᵢ) is O(2γN³), which is greater than the complexity of computing Ξᵢ⁻¹ directly, i.e., 0(N^{2.376}). Therefore, linear interpolation may be used instead for adj(Ξᵢ) and det(Ξᵢ). For example, subcarriers in [symbol] may be chosen such that the index difference of adjacent subcarriers is D=2^{l}. For any two adjacent subcarriers i,j∈ [symbol] and j−i=D, we may first compute Δ=(adj(Ξⱼ)−adj(Ξᵢ))/D and 67 =(det (Ξⱼ)−det (Ξᵢ))/D, which can be computed efficiently using bit shifting. For any subcarrier i<k<j, we have:

$${Ξ}_{k}^{- 1} \approx \frac{adj ( {Ξ}_{k - 1} ) + Δ}{det ( {Ξ}_{k - 1} ) + δ} , \qquad ( A59 )$$

which only needs N² additions and multiplications, respectively. The parameter D gives a tradeoff between performance and complexity.

Some aspects of the disclosure relate to column reordering. Column reordering of the channel matrix H has been recognized to be important to the performance of uncoded MIMO systems. If optimal joint MAP detection and decoding is used as shown in, for example, (A7), column reordering does not help. When the successive interference cancelation based algorithms described previously are considered, the order of processing different data streams may affect the computation of LLR value. Moreover, in practical systems, there may be only a single channel decoder.

Consequently, decoding of data streams may be done sequentially, and after a data stream is decoded, its update a priori information may be used for decoding of the remaining streams. This approach is different from other the algorithms where the updated a priori information is used only for the next iteration decoding not for the current one. In this case, different channel matrix reordering may lead to different convergence rate and performance.

Also different from techniques where only a single channel matrix is considered, the bits of each data stream in MIMO-OFDM span over several subcarriers. In addition, the whole data stream needs to be decoded before processing the next data stream. Therefore, the channel matrices on all subcarriers should prefereably be reordered in the same way. The difficulty is in taking all subcarriers' channels into account. To address this, a data stream with good channel conditions should preferably be decoded first such that the probability of successful decoding is high, and other data streams can benefit from this.

Two possible reordering schemes are described below. First, the reordering may be performed according the average SNR across the subcarriers, i.e.,

$$\frac{1}{{N}_{s}} \text{?} {h}_{i , j}^{H} {J ( {H}_{i , - j} {H}_{i , - j}^{H} + {σ}^{2} {I}_{N} )}^{- 1} {h}_{i , j} , j = 1 , … , M , \\ \text{?} \text{indicates text missing or illegible when filed} \qquad ( A60 )$$

where h_{i,j} is the j-th column of Hᵢ and H_{i,-j} constitutes the columns of Hᵢ except column j. The one with the largest (A60) may be decoded first, denoted as m. m may then be added into a set S which is initialized to be Ø. In the next step, it may be assumed that the stream m can be perfectly canceled, and find the next decoded stream according to:

$$\frac{1}{{N}_{s}} \text{?} {{h}_{i , j}^{H} ( {H}_{i , - \{ S , j \}} {H}_{i , - \{ S , j \}}^{H} + {σ}^{2} {I}_{N} )}^{- 1} {h}_{i , j} , j ∉ S . \\ \text{?} \text{indicates text missing or illegible when filed} \qquad ( 61 )$$

The data stream with the largest (61) not in S may be decoded and this data stream added in S. The process may then continue until all the data streams have been added into S.

In another implementation, capacity may be averaged to reorder the channel matrix rather than the average SNR. This may be done by replacing (A61) with

$$\frac{1}{{N}_{s}} \text{?} log ( 1 + {{h}_{i , j}^{H} ( {H}_{i , - \{ S , j \}} {H}_{i , - \{ S , j \}}^{H} + {σ}^{2} {I}_{N} )}^{- 1} {h}_{i , j} ) , j ∉ S . \\ \text{?} \text{indicates text missing or illegible when filed} \qquad ( A62 )$$

A Gaussian channel capacity formula is used in (62). However, capacity formulas for finite constellations may also be used. The computation of (A61) may be done iteratively as in (A56) and (A57). To save complexity, we can also simply reorder the data streams only based on (A60) without stream cancelation. In this case, we only need compute the SNR or capacity K times rather than K(K+1)/2 times.

The ordering can also be improved using the a priori information. When we consider the mutual information between yᵢ and xᵢ in (A5), for data stream j, (A5) can be written as:

yᵢ=Hᵢμᵢ+h_{i,j}\tilde{x}_{i,j}+H_{i,-j}\tilde{x}_{i,-j}+wᵢ, (A63)

where \tilde{x}_{i,j} is assumed to be Gaussian with mean zero and variance v_{i,j}². As a constant does not change mutual information, we have:

1(yᵢ;xᵢ)=log(1+h_{i,j}^{H}(H_{i,-j}Λ_{i,-j}H_{i,-j}^{H}+σ²I_{N})⁻¹h_{i,j}). (A64)

where Λ_{i,-j}=diag{v_{i,1}², . . . ,v_{i,j-1}²,v_{i,j+1}², . . . ,v_{i,M}²}, can be used instead of (A62) to reorder the data streams.

In some configurations, the apparatus for wireless communication includes means for performing various functions as described herein. In one aspect, the aforementioned means may be a processor or processors and associated memory in which embodiments reside, and which are configured to perform the functions recited by the aforementioned means. The aforementioned means may be, for example, modules or apparatus residing in UEs, eNBs, and/or other wireless network nodes, to perform the functions as are described herein. In another aspect, the aforementioned means may be a module or apparatus configured to perform the functions recited by the aforementioned means.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein. It is intended that the following claims and their equivalents define the scope of the disclosure.

What is claimed is:

1. A method for wireless communication, comprising:
generating a K-best set of values; and
summing the K-best set of values to generate a log likelihood ratio (LLR) metric;
wherein the K-Best set of values is determined based at least in part on an a priori priority value.

2. The method of claim 1, wherein the K-best set of values are generated by maximizing a conditional probability value of a first transmitted symbol conditioned on a probability of a received signal.

3. The method of claim 2, wherein the K-best set of values are generated by using a sum-log determination.

4. The method of claim 2, wherein the conditional probability value is generated using a Gaussian approximation of a second transmitted symbol.

5. The method of claim 2, wherein the conditional probability value is generated using a non-Gaussian approximation of a second transmitted symbol.

6. The method of claim 2, wherein the conditional probability value is generated using a second order polynomial approximation of a second transmitted symbol, and the K-best values are determined by searching from the minimum value of the polynomial function.

7. The method of claim 4, wherein the Gaussian approximation is determined in part by reducing the dimension of a matrix to generate a second matrix, and inverting the second matrix.

8. The method of claim 2, wherein the conditional probability is further based on a second transmitted symbol conditioned on the probability of the received signal, wherein a joint probability value of the first and second symbols conditioned on the received signal is maximized to determine the joint probability value.

9. A computer program product comprising a computer-readable storage medium including codes executable by a processor to:
generate a K-best set of values; and
sum the K-best set of values to generate a log likelihood ratio (LLR) metric;
wherein the K-Best set of values is determined based at least in part on an a priori priority value.

10. The computer program product of claim 9, wherein the K-best set of values are generated by maximizing a conditional probability value of a first transmitted symbol conditioned on a probability of a received signal.

11. The computer program product of claim 10, wherein the K-best set of values are generated by using a sum-log determination.

12. The computer program product claim 10, wherein the conditional probability value is generated using a Gaussian approximation of a second transmitted symbol.

13. The computer program product of claim 10, wherein the conditional probability value is generated using a non-Gaussian approximation of a second transmitted symbol.

14. The computer program product of claim 10, wherein the conditional probability value is generated using a second order polynomial approximation of a second transmitted symbol, and the K-best values are determined by searching from the minimum value of the polynomial function.

15. The computer program product of claim 12, wherein the Gaussian approximation is determined in part by reducing the dimension of a matrix to generate a second matrix, and inverting the second matrix.

16. The computer program product of claim 10, wherein the conditional probability is further based on a second transmitted symbol conditioned on the probability of the received signal, wherein a joint probability value of the first and second symbols conditioned on the received signal is maximized to determine the joint probability value.

17. An apparatus for wireless communication, comprising:
a processor configured to:
generate a K-best set of values; and
sum the K-best set of values to generate a log likelihood ratio (LLR) metric;
wherein the K-Best set of values is determined based at least in part on an a priori priority value; and
a memory coupled to the processor.

18. The apparatus of claim 17, wherein the a priori value based on information provided from a turbo decoder module.

19. The apparatus of claim 17, wherein the K-best set of values are generated by maximizing a conditional probability value of a first transmitted symbol conditioned on a probability of a received signal.

20. The apparatus of claim 19, wherein the K-best set of values are generated by using a sum-log determination.

21. The apparatus of claim 19, wherein the conditional probability value is generated using a Gaussian approximation of a second transmitted symbol.

22. The apparatus of claim 19, wherein the conditional probability value is generated using a non-Gaussian approximation of a second transmitted symbol.

23. The apparatus of claim 19, wherein the conditional probability value is generated using a second order polynomial approximation of a second transmitted symbol, and the K-best values are determined by searching from the minimum value of the polynomial function.

24. The apparatus of claim 21, wherein the Gaussian approximation is determined in part by reducing the dimension of a matrix to generate a second matrix, and inverting the second matrix.

25. The apparatus of claim 19, wherein the conditional probability is further based on a second transmitted symbol conditioned on the probability of the received signal, wherein a joint probability value of the first and second symbols conditioned on the received signal is maximized to determine the joint probability value.

26. An apparatus for wireless communication, comprising:
means for generating a K-best set of values; and
means for summing the K-best set of values to generate a log likelihood ratio (LLR) metric;
wherein the K-Best set of values is determined based at least in part on an a priori priority value.

27. A method for wireless communication, comprising:
determining a non-Gaussian approximation for a summation term of a log likelihood ratio (LLR) metric;
evaluating the non-Gaussian approximation of the summation term; and
generating the LLR metric based in part on the evaluation.

28. The method of claim 27, wherein the non-Gaussian function approximation corresponds to a probability mass function (pmf) associated with a transmitted symbol constellation.

29. The method of claim 28, wherein the pmf corresponds to one of a quadrature amplitude modulation (QAM) signal constellation, a phase shift keying (PSK) signal constellation and a phase amplitude modulation (PAM) signal constellation.

30. The method of claim 28, wherein the non-Gaussian function approximation is based on a polynomial-form approximation of the pmf.

31. The method of claim 30, wherein the polynomial-form approximation is a second order closed-form polynomial approximation of a higher-order function.

32. The method of claim 30, wherein the second order polynomial approximation is of the form:
Pr(X=x)=exp(−(c+2rx+ax²)).

33. The method of claim 27, wherein the generating the LLR metric comprises:
integrating the non-Gaussian function approximation for a first received signal and ones of a plurality of second received signals to generate a set of integral values; and
summing the set of integral values to generate the LLR.

34. The method of claim 27, further comprising decoding an input data stream based on the LLR metric.

35. A computer program product comprising a computer-readable storage medium including codes executable by a processor to:
determine a non-Gaussian approximation for a summation term of a log likelihood ratio (LLR) metric;
evaluate the non-Gaussian approximation of the summation term; and
generate the LLR metric based in part on the evaluation.

36. An apparatus for wireless communication, comprising:
a processor configured to:
determine a non-Gaussian approximation for a summation term of a log likelihood ratio (LLR) metric;
evaluate the non-Gaussian approximation of the summation term; and
generate the LLR metric based in part on the evaluation; and
a memory coupled to the processor.

37. The apparatus of claim 36, wherein the processor is further configured to decode an input data stream based on the LLR metric.

38. An apparatus for wireless communication, comprising:
means for determining a non-Gaussian approximation for a summation term of a log likelihood ratio (LLR) metric;
means for evaluating the non-Gaussian approximation of the summation term; and
means for generating the LLR metric based in part on the evaluation.

39. A method of generating a non-Gaussian approximation of a discrete probability mass function (pmf) summation for use in decoding a received signal, the method comprising:
determining a non-Gaussian function approximation corresponding to the pmf; and
integrating the non-Gaussian function to generate a value for use in decoding the received signal.

40. The method of claim 39, wherein the non-Gaussian function approximation is based on a polynomial-form approximation of the pmf.

41. The method of claim 40, wherein the polynomial-form approximation is a second order closed-form polynomial approximation of a higher-order function.

42. The method of claim 41, wherein the second order polynomial approximation is of the form:
Pr(X=x)=exp(−(c+2rx+ax²)).

43. A computer program product comprising a computer-readable storage medium including codes executable by a processor to:
determine a non-Gaussian function approximation corresponding to a discrete probability mass function (pmf); and
integrate the non-Gaussian function to generate a value for use in decoding a received signal.

44. An apparatus for generating a non-Gaussian approximation of a discrete probability mass function (pmf) summation for use in decoding a received signal, the apparatus comprising:
means for determining a non-Gaussian function approximation corresponding to the pmf; and
means for integrating the non-Gaussian function to generate a value for use in decoding the received signal.

45. An apparatus for generating a non-Gaussian approximation of a discrete probability mass function (pmf) summation for use in decoding a received signal, the apparatus comprising:
a processor configured to:
determine a non-Gaussian function approximation corresponding to the pmf; and
integrate the non-Gaussian function to generate a value for use in
decoding the received signal; and
a memory coupled to the processor.

46. A method for wireless communication, comprising:
generating a K-Best list of values based in part on an a priori value;
determining a summation based on the K-Best list of values; and
generating a log-likelihood ratio (LLR) metric based in part on the summation.

47. A computer program product comprising a computer-readable storage medium including codes executable by a processor to:
generate a K-Best list of values based in part on an a priori value;
determine a summation based on the K-Best list of values; and
generate a log-likelihood ratio (LLR) metric based in part on the summation.

48. An apparatus for decoding a transmitted signal, comprising:
a processor configured to:
generate a K-Best list of values based in part on an a priori value;
determine a summation based on the K-Best list of values; and
generate a log-likelihood ratio (LLR) metric based in part on the summation; and
a memory coupled to the processor.

49. An apparatus for wireless communication, comprising:
means for generating a K-Best list of values based in part on an a priori value provided from a turbo decoder;
means for determining a summation based on the K-Best list of values; and
means for generating a log-likelihood ratio (LLR) metric based in part on the summation.
